(19) United States
(12) Patent Application Publication
(10) Pub. No.: US 2011/0260620 A1
(43) Pub. Date: Oct. 27, 2011

(54) LIGHTING DEVICE, BACKLIGHT UNIT AND LIQUID CRYSTAL DISPLAY DEVICE

(75) Inventors: Kazuhiro Kumada, Himeji (JP); Shigeru Ido, Osaka (JP)

(73) Assignee: PANASONIC ELECTRIC WORKS CO., LTD., Osaka (JP)

(21) Appl. No.: 12/677,908

(22) PCT Filed: Sep. 16, 2008
(86) PCT No.: PCT/JP2008/066657

§ 371 Date: Mar. 12, 2010

(30) Foreign Application Priority Data
Sep. 21, 2007 (JP) 2007-246121
Dec. 25, 2007 (JP) 2007-331352

(51) Int. Cl. H05B 39/04

(52) U.S. Cl. 315/97

(57) ABSTRACT

A lighting device has: a lighting circuit for lighting a plurality of hot-cathode lamps having filaments at both ends; preheating circuits for preheating the individual filaments of the hot-cathode lamps; at least one first circuit substrate arranged near filaments on one side of the hot-cathode lamps; and at least one second circuit substrate arranged near filaments on the other side of the hot-cathode lamps. The lighting circuit is packaged in either the first circuit substrate or the second circuit substrate, and the preheating circuits are packaged or wired by being divided in the first circuit substrate and the second circuit substrate.

### TECHNICAL FIELD

The present invention relates to a lighting device for lighting hot-cathode lamps, a backlight unit provided with the lighting device, and a liquid crystal display device provided with the backlight unit.

### BACKGROUND ART

As a backlight unit for use in a liquid crystal display device, there is a direct system in which a plurality of discharge lamps; for instance, cold cathode lamps are housed in a case, and directly emitting light from the discharge lamps to the liquid crystal display panel arranged on the front face of the case.

In recent years, pursuant to the needs of large liquid crystal display devices, 50-inch screens and larger and even 100-inch screens are being marketed. Nevertheless, a cold cathode lamp has a thin tube diameter (the tube diameter of a cold cathode lamp that is generally used in LCD TVs is 3 mm to 4 mm) and is of low intensity, and sophisticated coating techniques are required since the tube diameter is thin. Thus, it was generally considered that a 65-inch screen (cold cathode lamp length is approximately 1500 mm) was the limit. In addition, since the amount of power that can be fed to a single cold cathode lamp is low, numerous cold cathode tubes are required (approximately 30 cold cathode tubes are required for a 65-inch screen) when attempting to obtain the intended brightness with the liquid crystal display device, and there is also another problem in that the lamp voltage is extremely high (approximately 2 kV with a 65-inch screen).

Thus, in recent years, hot-cathode lamps are attracting attention as the backlight for use in a large liquid crystal display device. Since the amount of power that can be fed to a single hot-cathode lamp is large, the number of lamps can be reduced, and there is an advantage in that the lamp voltage is 1/10 or less of a cold cathode lamp since it employs arc discharge.

Nevertheless, the hot-cathode lamp entails a different problem; for instance, there is the complication of the wiring. The lighting circuit of a standard hot-cathode lamp is shown in FIG. 15. In this figure, La1, La2 are hot-cathode lamps, F11, F21 are filaments of the hot-cathode lamp La1, F12, F22 are filaments of the hot-cathode lamp La2, L1, L2 are resonance inductors, C1, C3 are resonance capacitors, and C2, C4 are coupling capacitors. The foregoing components configure the lighting circuit. Y1, Y2 are preheating circuits. T1, T2 are preheating transfromers C11, C21 are coupling capacitors, and C12, C13, C22, C23 are preheating capacitors. As shown in FIG. 15, the voltage for lighting the lamp is applied to the lamp via a serial resonance circuit with the square wave voltage Vp as the power source, and the filament voltage for preheating the filaments are supplied to the filaments with the preheating transformers T1, T2 of the preheating circuits Y1, Y2 as the power source. In other words, to normally light the hot-cathode lamps, it is necessary to introduce the output from the lighting circuit and the output from the preheating circuit into the hot-cathode lamps, and a total of four terminals (four wires) are required as the input terminals to a single lamp.

Here, FIG. 16 shows the front view of the backlight unit in which four hot-cathode lamps are arranged in a case. Moreover, FIG. 17 is a back view of FIG. 16 and shows a circuit substrate K1 and wires. The broken line shows the perspective view of the opposite side. The circuit substrate K1 is mounted with two lighting devices (for lighting four lamps) of FIG. 15, and a total of sixteen wires; namely, a wire W1 to a wire W16 are required as wires from the circuit substrate K1 to the hot-cathode lamps La1 to La4. In particular, the wires (wire W9 to wire W16) on the side of the filaments F21 to F24 (low-voltage side of the circuit diagram of FIG. 15) will become lm or longer in cases of being used in a large backlight unit of 50 inches or larger, and there are other problems in which the number of wires will also become numerous, complicated wire drawing will be required, and the wire weight will increase. In addition, in the case of hot-cathode lamps, since the currently flowing through the wires is large at several hundred mA, conductive wires having a certain level of wire diameter are required, and there is a major problem concerning weight increase. In addition, since the low-voltage side wires are long, the inductance component of the conductive wires is large and, affected by this, the preheating current flowing through the filaments at both ends of the hot-cathode lamps tend to vary.

In FIG. 17, the reason why the circuit substrate K1 is arranged on the side of the filaments F11 to F14 (high-voltage side of the circuit diagram of FIG. 15) is because, under normal circumstances, a backlight unit is designed so as to reduce the parasitic capacitance between the high-voltage side wires and the case, and to reduce the current leak from the high-voltage side wires as much as possible. in due course

As a conventional example for resolving the problems regarding the large quantity and heavy weight of the low-voltage side wires of the hot cathode backlight unit as described above, there is Patent Document 1. Patent Document 1, as shown in FIG. 18, describes a method of using one lamp preheat voltage generation means Vf to collectively preheat high-voltage side filaments F11 to F14 and low-voltage side filaments F21 to F24 of a plurality of hot-cathode lamps La1 to La4. In particular, the preheating of the low-voltage side filaments F21 to F24 is performed by serially connecting the secondary winding n2 of a preheating transformer T1 and a plurality of low-voltage side filaments F21 to F24. Thus, when considering the case of using this in a backlight unit, as shown in FIG. 19, only two wires (serial wires between the respective low-voltage side filaments F21 to F24 are required); namely, a wire W1 and a wire W2, are required as the wires from the circuit substrate K1 to the plurality of low-voltage side filaments F21 to F24 regardless of the number of lamps.

In other words, as evident when comparing FIG. 17 with FIG. 19, if the means of Patent Document 1 is used, when lighting four hot-cathode lamps, whereas the configuration of FIG. 17 requires eight wires on the low-voltage side, the configuration of FIG. 19 only requires two wires. This will achieve compact wiring and the lighter weight of wires.

Nevertheless, in the configuration of Patent Document 1 shown in FIG. 18, since the output from the lamp lighting voltage generation means Vs is supplied to the respective hot-cathode lamps La1, La2, La1, La4 via the respective chokes L1, L2, L3, L4, the lamp current flowing therethrough will be the same phase. Normally, in a backlight unit of a liquid crystal display device, the phase of the lamp current of the discharge lamps arranged in the case is generally 180° different from the adjacent lamp, and the primary reason for this is to set off the noise generated from the magnetic field arising from the lamp current flowing in the plurality of discharge lamps with the opposite phase, to reduce the noise to the liquid crystal panel that is disposed on the front face of the discharge lamps via an optical sheet, and to reduce the far field that is generated from the liquid crystal display device. With respect to this point, in Patent Document 1, since the lamp current flowing through the adjacent lamps is the same phase, it is obvious that Patent Document 1 is disadvantageous as a backlight unit of a liquid crystal display device.

Moreover, in the configuration shown in FIG. 18, if the direction of the lamps is high-handedly switched in order to make the current of the adjacent lamps to be an opposite phase, the number of wires will increase. In addition, when focusing on the plurality of low-voltage side filaments F21 to F24 that are serially connected to the secondary winding n2 of the preheating transformer T1 in Patent Document 1, the lamp current of the respective hot-cathode lamps forms a loop that passes through the low-voltage side filaments of the other hot-cathode lamps. Specifically, in addition to the lamp current flowing from the hot-cathode lamp La1, the lamp current and the preheating current from the other hot-cathode lamps will be superposed and also flow to the low-voltage side filament F21 of the hot-cathode lamp La1. This means that the power to be consumed by the respective filaments will differ, and the setting conditions of the filament temperature that greatly affects the filament life will be extremely difficult and, in reality, the design thereof is difficult.

### Patent Document 1: Japanese Patent No. 3720390

### DISCLOSURE OF THE INVENTION

An object of this invention is to provide a lighting device using a plurality of hot-cathode lamps in which the miniaturization and lighter weight of wires are realized so that it can be suitably applied to a backlight unit of a liquid crystal display device and the like.

In order to achieve the foregoing object, the lighting device according to one aspect of the present invention comprises: a lighting circuit for lighting a plurality of hot-cathode lamps having filaments at both ends; a preheating circuit for preheating the individual filaments of the plurality of hot-cathode lamps; at least one first circuit substrate arranged near filaments on one side of the plurality of hot-cathode lamps; and at least one second circuit substrate arranged near filaments on the other side of the plurality of hot-cathode lamps, wherein the lighting circuit is packaged in either the first circuit substrate or the second circuit substrate, and wherein the preheating circuit is packaged or wired by being divided in the first circuit substrate and the second circuit substrate.

According to the foregoing configuration, the wiring structure can be realized merely by providing two preheat power source wires for preheating filaments near one of the circuit substrates between the first circuit substrate and the second circuit substrate. Accordingly, the number of lamp wires can be reduced and the lighter weight of the lighting device can be realized.

### BRIEF DESCRIPTION OF THE DRAWINGS

FIG. 1 shows a circuit diagram of the lighting device according to the first embodiment of the present invention;

FIG. 2 shows a circuit diagram of the lighting device according to the second embodiment of the present invention;

FIG. 3 shows a circuit diagram of the lighting device according to the third embodiment of the present invention;

FIG. 4 shows a circuit diagram of the lighting device according to the fourth embodiment of the present invention;

FIG. 5 shows a back view of the backlight unit using the lighting device according to the first to fourth embodiments of the present invention;

FIG. 6 shows a circuit diagram of the lighting device according to the fifth embodiment of the present invention;

FIG. 7 shows a back view of the backlight unit using the lighting device according to the fifth embodiment and the seventh embodiment of the present invention;

FIG. 8 shows a circuit diagram of the lighting device according to the sixth embodiment and the ninth embodiment of the present invention;

FIG. 9 shows a back view of the backlight unit using the lighting device according to the sixth embodiment of the present invention;

FIG. 10 shows a circuit diagram of the lighting device according to the seventh embodiment of the present invention;

FIG. 11 shows a circuit diagram of the lighting device according to the eighth embodiment of the present invention;

FIG. 12 shows a diagram explaining the operation of the lighting device according to the eighth embodiment of the present invention;

FIG. 13 shows a back view of the backlight unit using the lighting device according to the eighth embodiment of the present invention;

FIG. 14 shows an exploded perspective view showing the schematic configuration of the backlight unit of the present invention;

FIG. 15 shows a circuit diagram of a conventional lighting device;

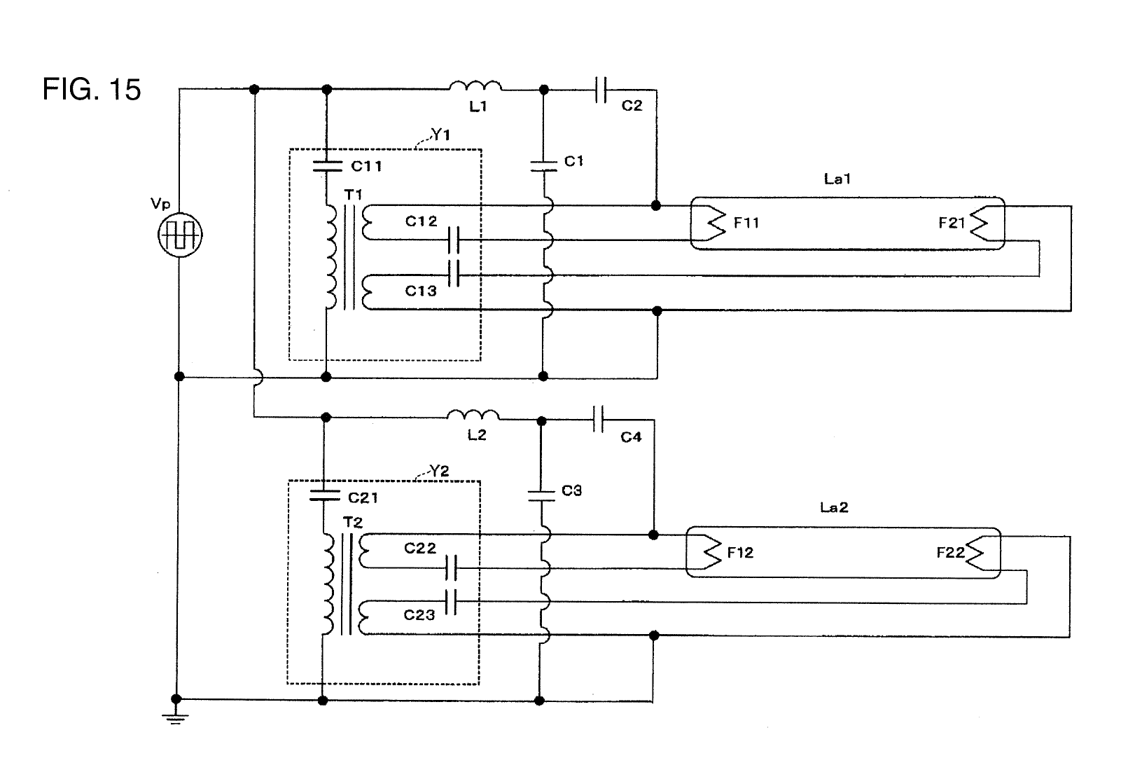

FIG. 16 shows a front view of the backlight unit using a conventional lighting device;

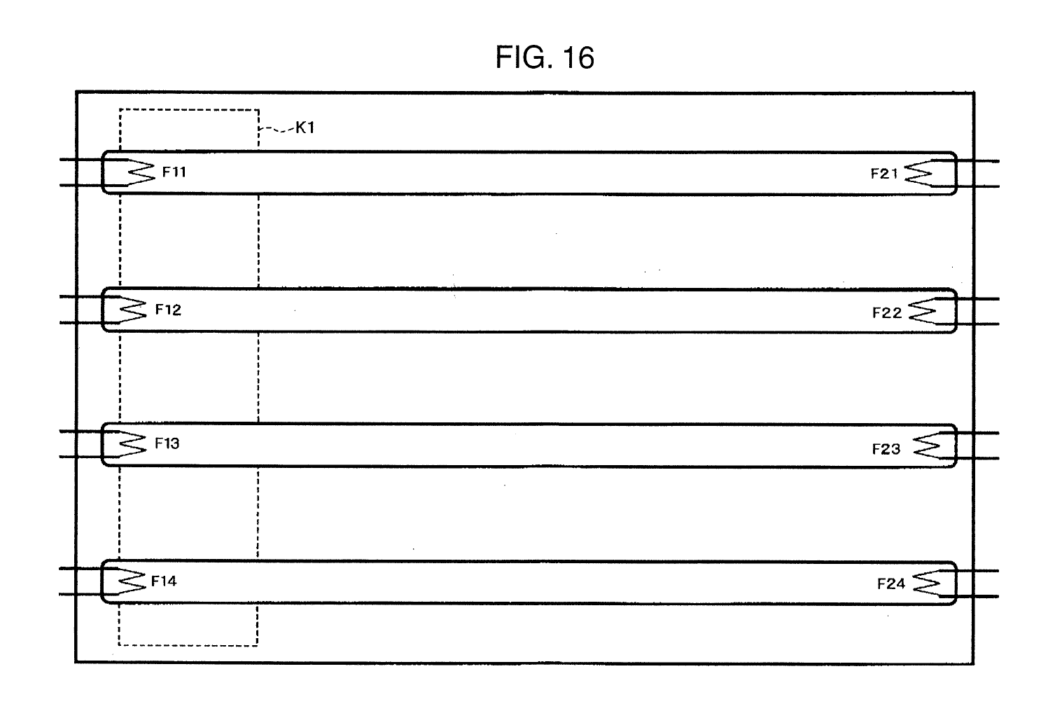

FIG. 17 shows a back view of the backlight unit using a conventional lighting device;

FIG. 18 shows a circuit diagram of the light device of Patent Document 1; and

FIG. 19 shows a back view of the backlight unit using the lighting device of Patent Document 1.

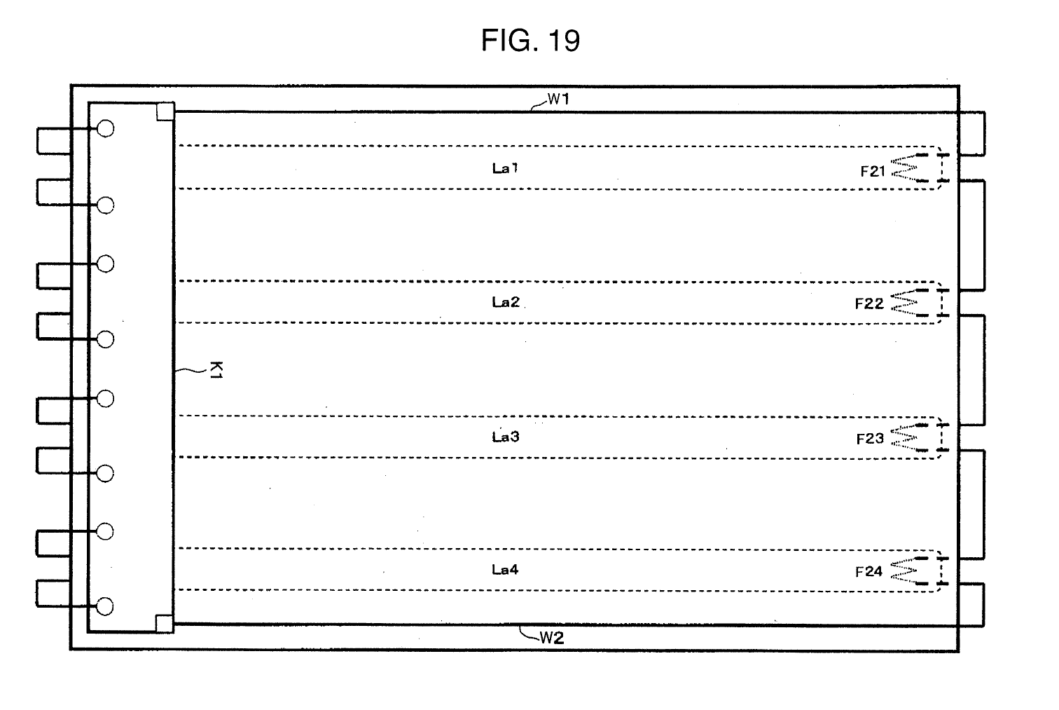

### BEST MODE FOR CARRYING OUT THE INVENTION

Embodiments of the present invention are now explained with reference to the attached drawings.

### First Embodiment

An embodiment of a backlight unit and a liquid crystal display device using the lighting device of the present invention is now explained. The lighting device of this invention is used, for example, as the lighting device of a backlight unit for use in a liquid crystal display device.

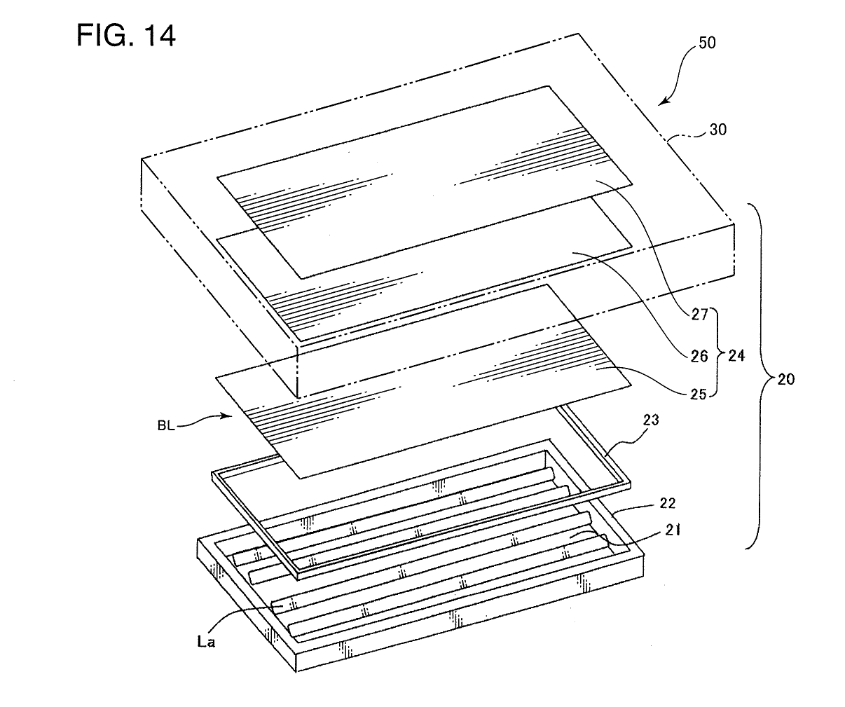

As shown in FIG. 14, a liquid crystal display device 50 of the present embodiment includes a liquid crystal panel 30, and a backlight unit BL disposed on the back side of the liquid crystal panel 30.

To briefly explain the configuration of the backlight unit of the present invention with reference to FIG. 14, the backlight unit BL comprises a plurality of hot-cathode lamps La, and a case 20 for housing the hot-cathode lamps La. Here, the hot-cathode lamps La comprise filaments at both ends of a glass tube. The backlight unit BL is used by being disposed on the reverse side of the backlight of the liquid crystal panel 30, and the case 20 comprises a reflecting plate 21, a side plate 22, amounting frame 23, a translucent plate 24, and a lighting device (not shown: generally disposed on the reverse side of the backlight of the backlight unit BL). Generally speaking, the translucent plate 24 is configured by laminating, in order from the reverse side of the backlight, a diffusion plate 25, a diffusion sheet 26, and a lens sheet 27. Light from the plurality of hot-cathode lamps La that are lit with the lighting device in the foregoing configuration is diffused upon passing through the diffusion plate 25, and emitted as averaged parallel light from the entire surface of the diffusion sheet 26.

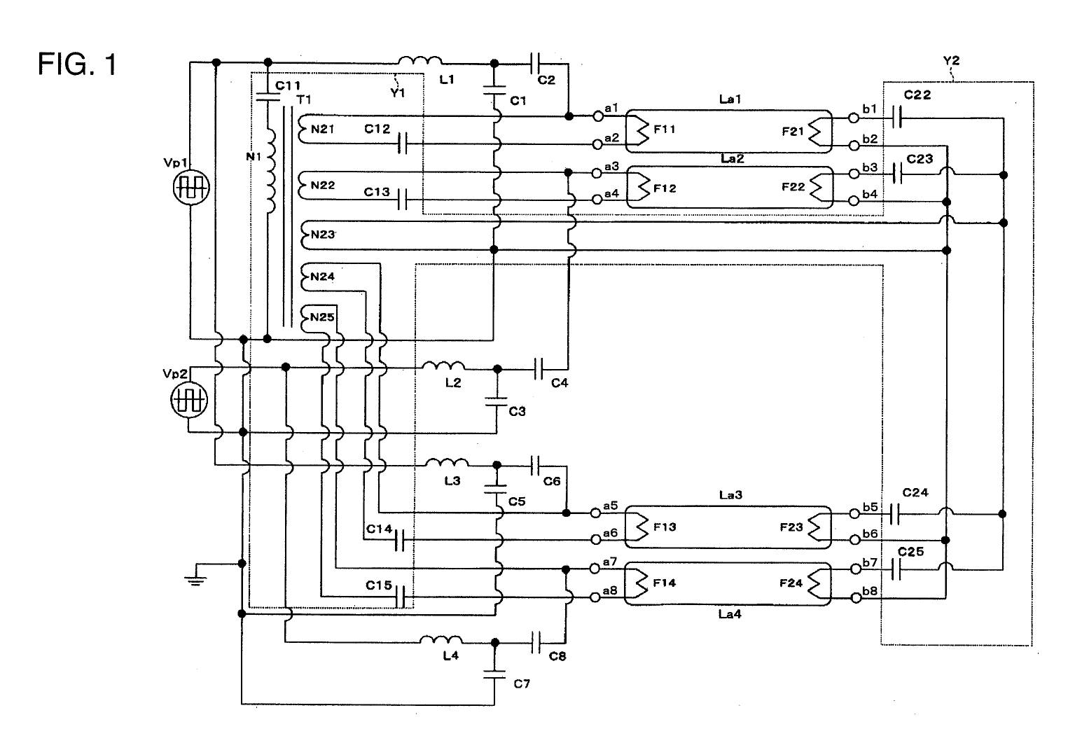

The lighting device according to the first embodiment is now explained with reference to FIG. 1. The lighting device comprises four hot-cathode lamps La1, La2, La3, La4, four lighting circuits for applying voltage to and lighting the four hot-cathode lamps, and one preheating circuit for preheating the filaments of the four hot-cathode lamps.

The first lighting circuit is configured from the positive/negative symmetrical square wave voltage (first lighting AC voltage) Vp1 output as a result of a half bridge inverter circuit or a full bridge inverter circuit switching the DC voltage, and a serial resonance circuit of an inductor L1 and a capacitor C1 using the Vp1 as its power source. One end of the resonance capacitor C1 is connected to one end of the hot-cathode lamp La1 via a DC cut capacitor C2, and the other end is connected to the ground.

The second lighting circuit is configured from a square wave voltage (second lighting AC voltage) Vp2 in which the phase is 180° different (opposite phase) from the square wave voltage Vp1, and a serial resonance circuit of an inductor L2 and a capacitor C3 using the Vp2 as its power source, and one end of the resonance capacitor C3 is connected to one end of the hot-cathode lamp La2 via a DC cut capacitor C4, and the other end is connected to the ground.

The configuration of the third and fourth lighting circuits for lighting the hot-cathode lamps La3, La4 is the same as the configuration of the first and second lighting circuits, respectively, and the redundant explanation thereof is omitted.

According to the foregoing configuration, a lamp current of the same phase will flow through the hot-cathode lamps La1 and La3, and a current of the same phase will also flow through the hot-cathode lamps La2 and La4. The lamp current flowing through the hot-cathode lamps La1 and La3 and the lamp current flowing through the hot-cathode lamps La2 and La4 are of an opposite phase.

With the configuration of the present embodiment, as shown in FIG. 1, a high-voltage AC voltage is applied to filaments F11 to F14 on one side of the hot-cathode lamps, and filaments F21 to F24 on the other side is connected to the ground.

The preheating circuit is configured from a preheating circuit Y1 for preheating the filaments F11, F12, F13, F14 on the high-voltage side (side that the high-voltage AC voltage is applied) and the filaments F21, F22, F23, F24 connected to the low-voltage side (ground side). Specifically, the filaments on the high-voltage side and the low-voltage side of the respective hot-cathode lamps are preheated with the preheating circuit Y1.

The preheating circuit Y1 uses the square wave voltage Vp1 as its power source, and is configured from a series circuit of a primary winding of a capacitor C11 and a preheating transformer T1. The preheating transformer T1 includes five secondary windings, and the secondary windings N21, N22, N24, N25 are respectively connected to the filaments F11 to F14 on the high-voltage side of the hot-cathode lamps La1 to La4, and respectively preheat the filaments via the capacitors C12, C13, C14, C15. The low-voltage side filaments F21 to F24 are respectively preheated via the capacitors C22 to C25 with the secondary winding N23 as the power source.

Although it has been explained that the high-voltage side filament and the low-voltage side filaments of the respective hot-cathode lamps La1 to La4 are preheated with the preheating circuit Y1, the present embodiment is additionally characterized in that the preheating circuit Y1 is packaged or wired by being divided in different circuit substrates.

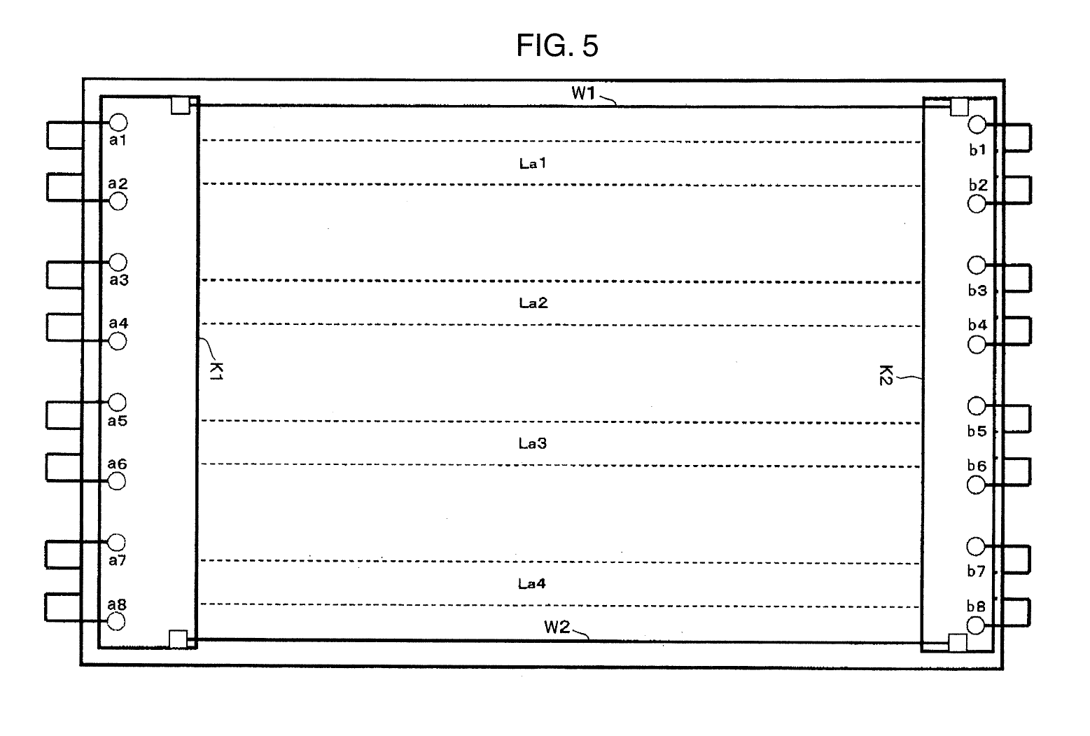

The configuration of the backlight unit comprising the lighting device of the present embodiment shown in FIG. 1 is now explained with reference to FIG. 5. FIG. 5 shows the configuration where the backlight unit comprises a circuit substrate K1 (first circuit substrate) and a circuit substrate K2 (second circuit substrate) in which the foregoing lighting device is packaged, and FIG. 14 is a view from the reverse side of the backlight. For example, the circuit substrate K1 is packaged with the four lighting circuits of the lighting device shown in FIG. 1 and capacitors C11 to C15 and a preheating transformer T1 as the components of the preheating circuit Y1, and the circuit substrate K2 is packaged or wired with capacitors C22 to C25 and preheating wires of filaments F21 to F24 as components of the preheating circuit Y2. As the circuit substrate material, paper phenol, glass epoxy and the like are generally used.

Only the power source of the preheating circuit; that is, the secondary winding N23 (two wires) of the preheating transformer T1 for preheating the low-voltage side filaments F21 to F24 is required as the wires between the circuit substrate K1 and the circuit substrate K2. Specifically, the output lines from the secondary winding N23 of the preheating transformer T1 of FIG. 1 correspond to the wire W1 and the wire W2 of FIG. 5.

To explain the wiring to the hot-cathode lamps La1 to La4, a terminal a1 and a terminal a2 of the circuit substrate K1 in which the four lighting circuits and a part of the preheating circuit Y1 are packaged are wired to the filament F11 of the hot-cathode lamp La1, a terminal a3 and a terminal a4 are wired to the filament F12 of the hot-cathode lamp La2, a terminal a5 and a terminal a6 are wired to the filament F13 of the hot-cathode lamp La3, and a terminal a7 and a terminal a8 are wired to the filament F14 of the hot-cathode lamp La4. Moreover, a terminal b1 and a terminal b2 of the circuit substrate K2 in which apart of the preheating circuit Y1 is packaged are wired to the filament F21 of the hot-cathode lamp La1, a terminal b3 and a terminal b4 are wired to the filament F22 of the hot-cathode lamp La2, a terminal b5 and a terminal b6 are wired to the filament F23 of the hot-cathode lamp La3, and a terminal b7 and a terminal b8 are wired to the filament F24 of the hot-cathode lamp La4. However, since the terminal b2, the terminal b4, the terminal b6, and the terminal b8 are a terminal (ground) of the same potential, they are connected via a pattern on the circuit substrate K2. These are the same potential (ground) as one of the wiring from the circuit substrate K1 to the circuit substrate K2.

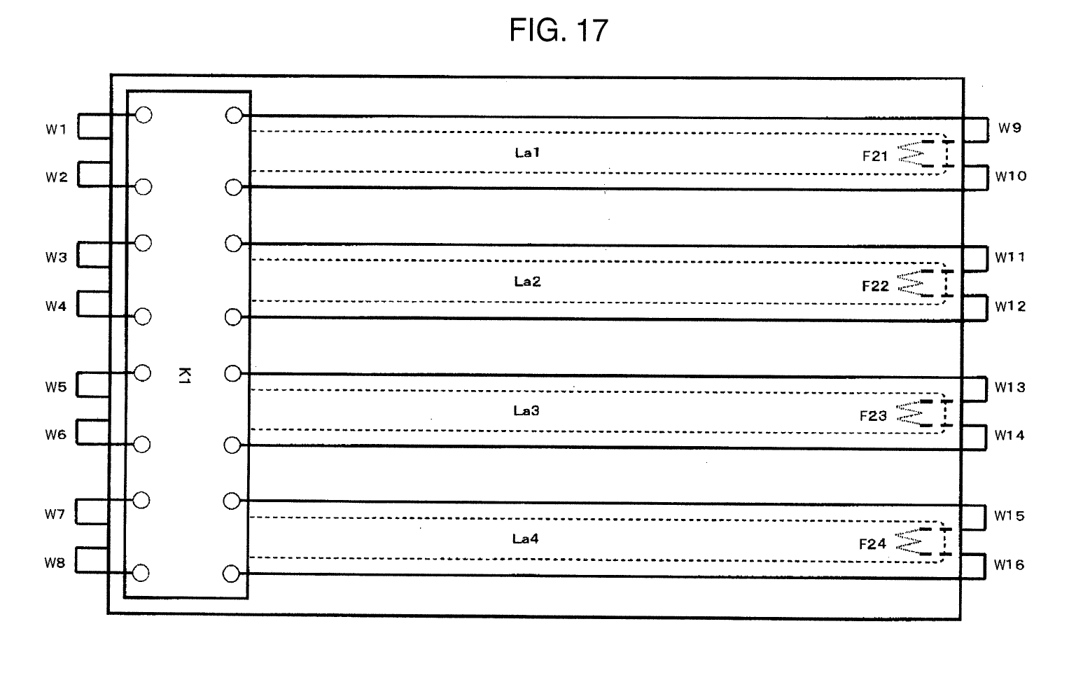

The configuration of the lighting device and the backlight unit of the present embodiment is as explained above, and now the effect thereof is explained. Foremost, as a result of preheating the high-voltage side filaments F11, F12, F13, F14 and the low-voltage side filaments F21, F22, F23, F24 of the hot-cathode lamps La1, La2, La3, La4 with the preheating circuit Y1, and packaging the preheating circuit Y1 by dividing it in the circuit substrate K1 and the circuit substrate K2 disposed at the backlight reverse side of the backlight as described above, since the power source (secondary winding N23 of the preheating transformer T1) of the preheating circuit of the low-voltage side filaments only needs to be wired from the circuit substrate K1 to the circuit substrate K2, in comparison to the conventional configuration shown in FIG. 17, the number of lamp wires can be reduced significantly, and the lighter weight and miniaturization of the backlight unit are enabled.

Moreover, since the configuration of the present embodiment uses the circuit substrate K1 and the circuit substrate K2 as described above, if these are arranged on either side of the backlight unit, the weight balance is improved in comparison to a configuration of disposing the circuit substrates on one side.

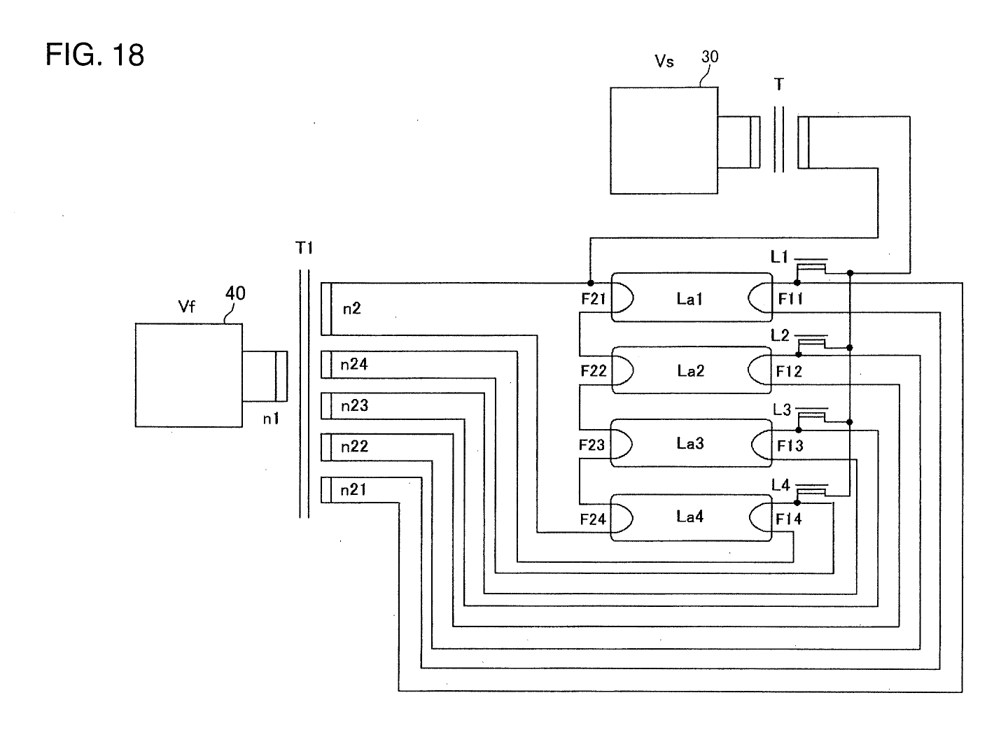

In addition, as a result of flowing a lamp current of an opposite phase to the adjacent hot-cathode lamps with the lighting circuit, if the lighting device of the present embodiment is mounted on a backlight unit, the lamp current of the adjacent hot-cathode lamps can be made to be an opposite phase, which was not possible with the configuration of Patent Document 1 shown in FIG. 18. The result is a lighting device capable of setting off the magnetic field generated from the hot-cathode lamp and reducing the noise to the liquid crystal panel.

### Second Embodiment

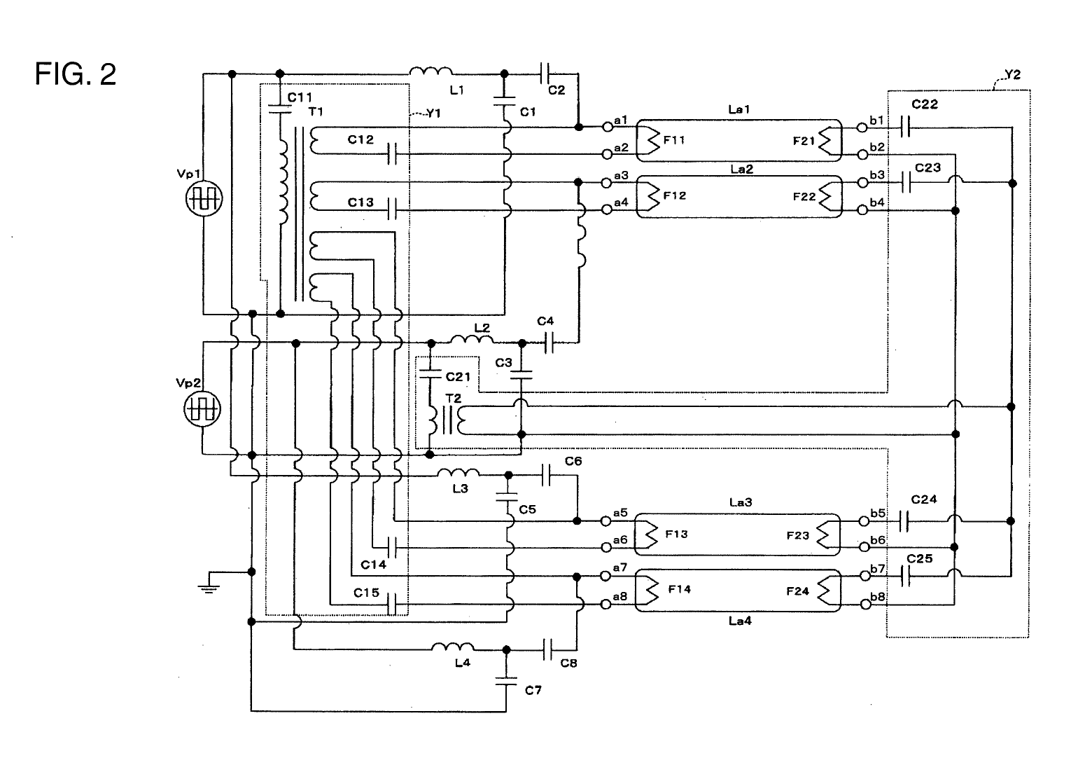

The lighting device according to the second embodiment is now explained with reference to FIG. 2. This lighting device comprises four hot-cathode lamps La1, La2, La3, La4, four lighting circuits for applying voltage to and lighting the four hot-cathode lamps, and two preheating circuits for preheating the filaments of the four hot-cathode lamps. Since the lighting circuits are configured the same as the first embodiment, the explanation thereof is omitted.

The preheating circuit is configured from a preheating circuit (first preheating circuit) Y1 for preheating the filaments F11, F12, F13, F14 on the high-voltage side (side that the high-voltage AC voltage is applied), and a preheating circuit (second preheating circuit) Y2 for preheating the filaments F21, F22, F23, F24 connected to the low-voltage side (ground side).

The preheating circuit Y1 uses the square wave voltage Vp1 as its power source, and is configured from a series circuit of a primary winding of a capacitor C11 and a preheating transformer T1. The preheating transformer T1 includes four secondary windings, and the secondary windings are respectively connected to the filaments F11 to F14 on the high-voltage side of the hot-cathode lamps La1 to La4, and respectively preheat the filaments via the capacitors C12, C13, C14, C15.

The preheating circuit Y2 uses the voltage Vp2 having an opposite phase of the square wave voltage Vp1 as its power source, and is configured from a series circuit of a primary winding of a capacitor C21 and a preheating transformer T2. The preheating transformer T2 includes one secondary winding, wherein the secondary winding is the power source of the preheating circuit for preheating the low-voltage side filaments F21 to F24 of the hot-cathode lamps La1 to La4, and preheats the filaments via the respective capacitors C22, C23, C24, C25. The square wave power source of the preheating circuit Y2 is not limited to Vp2, and it may also be Vp1.

The high-voltage side filaments of the respective hot-cathode lamps La1 to La4 are prepared with the preheating circuit Y1, and the low-voltage side filaments are preheated with the preheating circuit Y2 as explained above. The present embodiment is characterized in that the preheating circuit Y2 is packaged or wired by being dividing in different circuit substrates.

The configuration of the backlight unit comprising the lighting device of the present embodiment shown in FIG. 2 is now explained with reference to FIG. 5. For example, the circuit substrate K1 is packaged with the four lighting circuits and the preheating circuit Y1 of the lighting device shown in FIG. 2, as well as the capacitor C21 and the preheating transformer T2 as partial components of the preheating circuit Y2, and the circuit substrate K2 is packaged or wired with the capacitors C22 to C25 and the preheating wires of the filaments F21 to F24 as the remaining components of the preheating circuit Y2.

Only the power source of the preheating circuit; that is, the secondary winding (two wires) of the preheating transformer T2 for preheating the low-voltage side filaments F21 to F24 is required as the wires between the circuit substrate K1 and the circuit substrate K2. Specifically, the output lines from the secondary winding of the preheating transformer T2 of FIG. 2 correspond to the wire W1 and the wire W2 of FIG. 5.

To explain the wiring to the hot-cathode lamps La1 to La4, a terminal a1 and a terminal a2 of the circuit substrate K1 in which the four lighting circuits, the preheating circuit Y1 and a part of the preheating circuit Y2 are packaged are wired to the filament F11 of the hot-cathode lamp La1, a terminal a3 and a terminal a4 are wired to the filament F12 of the hot-cathode lamp La2, a terminal a5 and a terminal a6 are wired to the filament F13 of the hot-cathode lamp La3, and a terminal a7 and a terminal a8 are wired to the filament F14 of the hot-cathode lamp La4. Moreover, a terminal b1 and a terminal b2 of the circuit substrate K2 in which the remainder of the preheating circuit Y2 is packaged are wired to the filament F21 of the hot-cathode lamp La1, a terminal b3 and a terminal b4 are wired to the filament F22 of the hot-cathode lamp La2, a terminal b5 and a terminal b6 are wired to the filament F23 of the hot-cathode lamp La3, and a terminal b7 and a terminal b8 are wired to the filament F24 of the hot-cathode lamp La4. However, since the terminal b2, the terminal b4, the terminal b6, and the terminal b8 are a terminal (ground) of the same potential, they are connected via a pattern on the circuit substrate K2. These are the same potential (ground) as one of the wiring from the circuit substrate K1 to the circuit substrate K2.

The configuration of the lighting device and the backlight unit of the present embodiment is as explained above, and now the effect thereof is explained. Foremost, as a result of preheating the high-voltage side filaments F11, F12, F13, F14 of the hot-cathode lamps La1, La2, La3, La4 with the preheating circuit Y1 and preheating the low-voltage side filaments F21, F22, F23, F24 with the preheating circuit Y2, packaging four lighting circuits, the preheating circuit Y1 and a part of the preheating circuit Y2 in the circuit substrate K1 disposed at the backlight reverse side of the backlight and packaging a part of the preheating circuit Y2 in the circuit substrate K2 as described above, since the power source of the preheating circuit; that is, the secondary winding of the preheating transformer T2, of the low-voltage side filaments only needs to be wired from the circuit substrate K1 to the circuit substrate K2, in comparison to the conventional configuration shown in FIG. 17, the number of lamp wires can be reduced significantly, and the lighter weight and miniaturization of the backlight unit are enabled.

Moreover, the present embodiment preheats the high-voltage side filaments and the low-voltage side filaments with different preheating circuits. As evident from FIG. 2, although a preheating current for preheating one filament flows in the secondary winding of the preheating transformer T1 of the preheating circuit Y1, a preheating current for preheating four low-voltage side filaments F21 to F24 flows in the secondary winding of the preheating transformer T2 of the preheating circuit Y2. In other words, when considering that equal preheating current is to be supplied to the respective filaments, the preheating current flowing in the secondary winding of the preheating transformer T2 will be approximately four times the preheating current flowing in the secondary winding of the preheating transformer T1. For example, if, as in the first embodiment, the secondary winding for preheating the high-voltage side filaments and the secondary winding for preheating the low-voltage side filaments are wound around the same preheating transformer, since the current flowing in the secondary windings is considerably different as described above, the balance of the coefficient of coupling between the winding wires of the preheating transformer will be lost (if conductive wires having different wire diameters are used, the parasitic capacitance and wire resistance of the respective secondary windings will differ), this may cause variance in the preheating current. In addition, since the wire diameter of the secondary winding for preheating the low-voltage side filaments will become thick, there are cases where it would be more advantageous, in terms of cost, to independently provide a preheating transformer for preheating the low-voltage side filaments instead of enlarging the preheating transformer as a result of consolidating them into a single preheating circuit. Based on the foregoing reasons, the present embodiment preheats the high-voltage side filaments and the low-voltage side filaments with different preheating circuits. Moreover, since the high-voltage side filaments and the low-voltage side filaments are preheated with different preheating circuits, for instance, a method of preheating the high-voltage side filaments with the winding preheating method, and preheating the low-voltage side filaments with the DC voltage preheating method may be considered, and the freedom of design is high.

### Third Embodiment

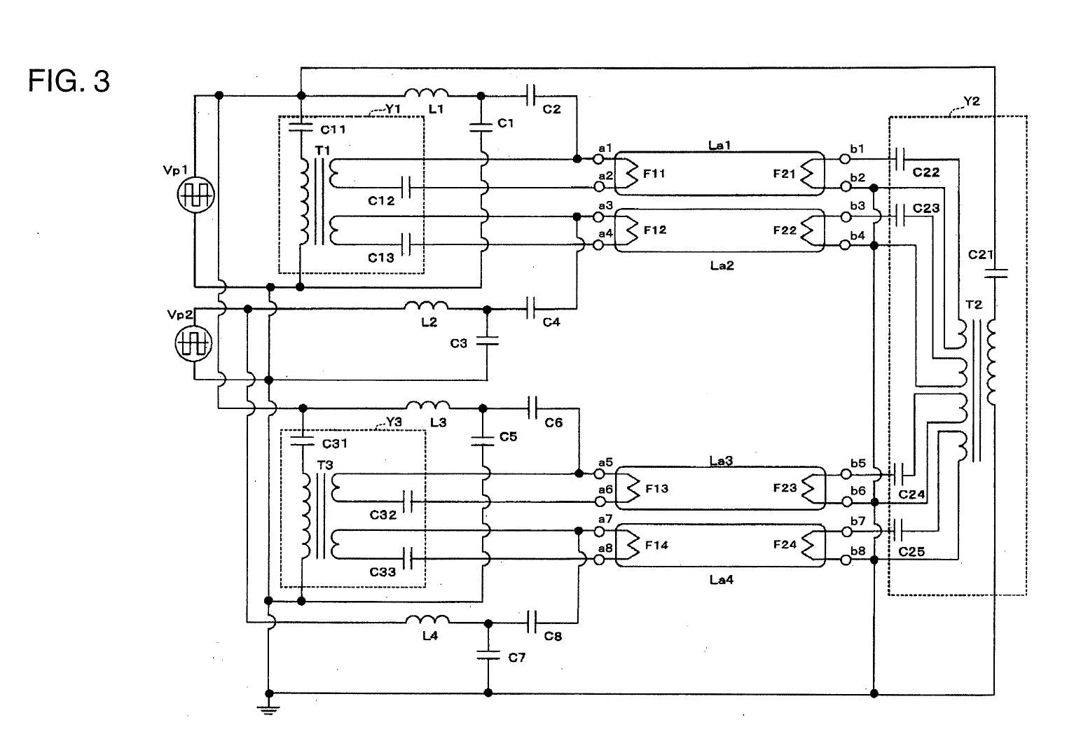

The lighting device according to the third embodiment is now explained with reference to FIG. 3. This lighting device comprises four hot-cathode lamps La1, La2, La3, La4, four lighting circuits for applying voltage to and lighting the four hot-cathode lamps, and three preheating circuits for preheating the filaments of the four hot-cathode lamps.

The first lighting circuit is configured from the positive/negative symmetrical square wave voltage Vp1 output as a result of a half bridge inverter circuit or a full bridge inverter circuit switching the DC voltage, and a serial resonance circuit of an inductor L1 and a capacitor C1 using the Vp1 as its power source. One end of the resonance capacitor C1 is connected to one end of the hot-cathode lamp La1 via a DC cut capacitor C2, and the other end is connected to the ground.

The second lighting circuit is configured from a square wave voltage Vp2 having an opposite phase of the square wave voltage Vp1, and a serial resonance circuit of an inductor L2 and a capacitor C3 using the Vp2 as its power source, and one end of the resonance capacitor C3 is connected to one end of the hot-cathode lamp La2 via a DC cut capacitor C4, and the other end is connected to the ground.

The configuration of the third and fourth lighting circuits for lighting the hot-cathode lamps La3, La4 is the same as the configuration of the first and second lighting circuits, respectively, and the redundant explanation thereof is omitted.

According to the foregoing configuration, a lamp current of the same phase will flow through the hot-cathode lamps La1 and La3, and a current of the same phase will also flow through the hot-cathode lamps La2 and La4. The lamp current flowing through the hot-cathode lamps La1 and La3 and the lamp current flowing through the hot-cathode lamps La2 and La4 are of an opposite phase.

With the configuration of the present embodiment, as shown in FIG. 3, a high-voltage AC voltage is applied to filaments F11 to F14 on one side of the hot-cathode lamps, and filaments F21 to F24 on the other side is connected to the ground.

The preheating circuit is configured from preheating circuits (high-voltage side preheating circuits) Y1 and Y3 for preheating the filaments F11, F12, F13, F14 on the high-voltage side (side that the high-voltage AC voltage is applied), and a preheating circuit (low-voltage side preheating circuit) Y2 for preheating the filaments F21, F22, F23, F24 connected to the low-voltage side (ground side). Specifically, the high-voltage side filaments of the respective hot-cathode lamps are preheated with the preheating circuit Y1 and the preheating circuit Y3, and the low-voltage side filaments are preheated with the preheating circuit Y2.

The preheating circuit Y1 uses the square wave voltage Vp1 as its power source, and is configured from a series circuit of a primary winding of a capacitor C11 and a preheating transformer T1. The preheating transformer T1 includes two secondary windings, and the respective secondary windings are connected to the high-voltage side filaments F11, F12 of the hot-cathode lamps La1, La2, and respectively preheat the filaments via the capacitors C12, C13. Similarly, the preheating circuit Y3 preheats the high-voltage side filaments F13, F14 of the hot-cathode lamps La3, La4.

The preheating circuit Y2 uses the square wave voltage Vp1 as its power source, and is configured from a series circuit of a primary winding of a capacitor C21 and a preheating transformer T2 in relation to the power source Vp1. The preheating transformer T2 includes four secondary windings, and the respective secondary windings are connected to the low-voltage side filaments F21, F22, F23, F24 of the hot-cathode lamps La1, La2, La3, La4.

The high-voltage side filaments of the respective hot-cathode lamps La1 to La4 are preheated with the preheating circuits Y1 and Y3, and the low-voltage side filaments are separately preheated with the preheating circuit Y2 as explained above. The present embodiment is additionally characterized in that the preheating circuits Y1 and Y3 for preheating the high-voltage side filaments and the preheating circuit Y2 for preheating the low-voltage side filaments are packed in different circuit substrates.

The configuration of the backlight unit comprising the lighting device of the present embodiment shown in FIG. 3 is now explained with reference to FIG. 5. FIG. 5 shows the configuration where the backlight unit comprises a circuit substrate K1 and a circuit substrate K2 in which the foregoing lighting device is packaged, and FIG. 14 is a view from the reverse side of the backlight. For example, the circuit substrate K1 is packaged with the four lighting circuits and the preheating circuits Y1, Y3 of the lighting device shown in FIG. 3, and the circuit substrate K2 is packaged with the preheating circuit Y2. As the circuit substrate material, paper phenol, glass epoxy and the like are generally used.

Only two wires (wire W1 and wire W2 of FIG. 5) for supplying power to the preheating circuit Y2 that is packaged in the circuit substrate K2 are required as the wiring between the circuit substrate K1 and the circuit substrate K2. Moreover, the square wave power source of the preheating circuit Y2 may also be Vp2.

To explain the wiring to the hot-cathode lamps La1 to La4, a terminal a1 and a terminal a2 of the circuit substrate K1 in which the lighting circuits and the preheating circuits Y1, Y3 are packaged are wired to the filament F11 of the hot-cathode lamp La1, a terminal a3 and a terminal a4 are wired to the filament F12 of the hot-cathode lamp La2, a terminal a5 and a terminal a6 are wired to the filament F13 of the hot-cathode lamp La3, and a terminal a7 and a terminal a8 are wired to the filament F14 of the hot-cathode lamp La4. Moreover, a terminal b1 and a terminal b2 of the circuit substrate K2 in which the preheating circuit Y2 is packaged are wired to the filament F21 of the hot-cathode lamp La1, a terminal b3 and a terminal b4 are wired to the filament F22 of the hot-cathode lamp La2, a terminal b5 and a terminal b6 are wired to the filament F23 of the hot-cathode lamp La3, and a terminal b7 and a terminal b8 are wired to the filament F24 of the hot-cathode lamp La4. However, since the terminal b2, the terminal b4, the terminal b6, and the terminal b8 are a terminal (ground) of the same potential, they are connected via a pattern on the circuit substrate K2. These are the same potential (ground) as one of the wire W2 (ground) from the circuit substrate K1.

The configuration of the lighting device and the backlight unit of the present embodiment is as explained above, and now the effect thereof is explained. Foremost, the high-voltage side filaments F11, F12, F13, F14 of the hot-cathode lamps La1, La2, La3, La4 are preheated with the preheating circuits Y1 and Y3, the low-voltage side filaments F21, F22, F23, F24 of the hot-cathode lamps La1, La2, La3, La4 are preheated with the preheating circuit Y2, the circuit substrate K1 disposed at the backlight reverse side of the backlight is packed with the four lighting circuits and the preheating circuits Y1 and Y3, and the circuit substrate K2 is packaged with the preheating circuit Y2. Since only a square wave power source (two wires) for supplying power to the preheating circuit Y2 is required as the wiring between the circuit substrate K1 and the circuit substrate K2 as a result of packaging the preheating circuit Y1 and the preheating circuit Y2 in separate circuit substrates, in comparison to the conventional configuration shown in FIG. 17, the number of lamp wires can be reduced significantly, and the lighter weight and miniaturization of the backlight unit are enabled.

Moreover, in the present embodiment, since the preheating circuits Y1, Y3 for preheating the high-voltage side filaments are packaged in the circuit substrate K1, and the preheating circuit Y2 for preheating the low-voltage side filaments is packaged in the circuit substrate K2, the respective filaments and the preheating transformer of the preheating circuits for preheating such filaments will be arranged at a close distance. In other words, with the configuration of the present embodiment, since the distance from the secondary winding of the preheating transformer to the filament is short, the inductance component of the preheating wires from the secondary winding of the preheating transformer to the filaments will be small, and variation in the preheating current of the respective filaments can thereby reduced.

Moreover, if the circuit substrates K1, K2 are disposed on either side of the backlight unit in the present embodiment, since both of the circuit substrates K1, K2 are packaged with the preheating transformer of the preheating circuit, the lateral weight balance will be superior in comparison to cases where only one substrate is packaged with the preheating transformer. In addition, as a result of flowing a lamp current of an opposite phase to the adjacent hot-cathode lamps with the lighting circuit, if the lighting device of the present embodiment is mounted on a backlight unit, the lamp current of the adjacent hot-cathode lamps can be made to be an opposite phase, which was not possible with the configuration of Patent Document 1 shown in FIG. 18. The result is a lighting device capable of setting off the magnetic field generated from the hot-cathode lamp and reducing the noise to the liquid crystal panel.

### Fourth Embodiment

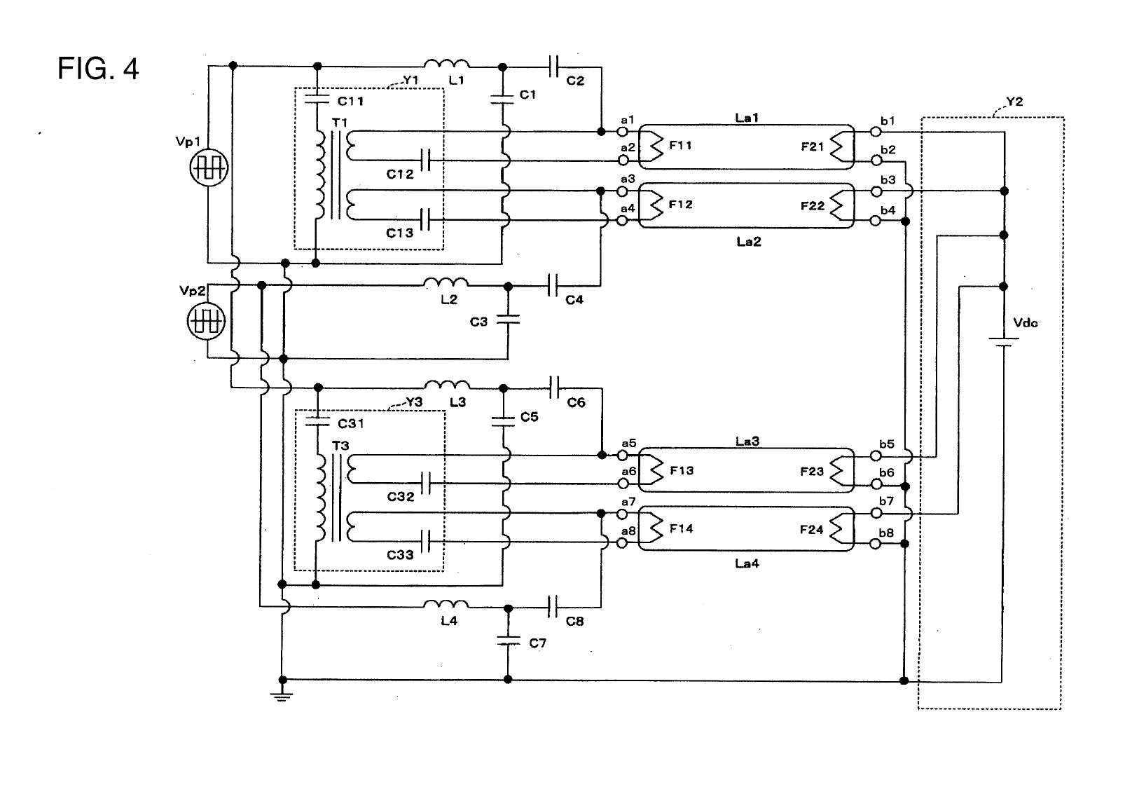

The lighting device according to the fourth embodiment is now explained with reference to FIG. 4. This lighting device is configured basically the same as with the third embodiment, but differs in that the preheating circuit Y2 for preheating the low-voltage side filaments employs the DC voltage preheating method, and not the winding preheating method. Since FIG. 4 adopts a configuration where the DC power source Vdc exists in the circuit substrate K2, only a ground wire is required for the wiring between the circuit substrate K1 and the circuit substrate K2. If the DC power source Vdc is provided to the circuit substrate K1, two wires; namely, the DC power source Vdc and the ground wire are required for the wiring between the circuit substrate K1 and the circuit substrate K2.

The effect of the present embodiment is now explained. Under normal circumstances, the hot-cathode lamps use a different preheating current when they are to be fully lit and when they are to be dimmed, and in particular it is necessary to increase the preheating current during the dimming in comparison to full lighting. This is in order to set the filament temperature to an appropriate value of approximately 800° C. to 1000° C. and ensuring the life thereof, and in particular since the lamp current will decrease during the dimming, it is necessary to increase the preheating current and thereby increase the filament temperature. Although the winding preheating method is superior for controlling the increase and decrease of the preheating current in accordance with the dimming level, if there is no need to control the dimming and the preheating current may be constant, the adoption of the DC voltage preheating method is able to realize the lighter weight and simplification of the lighting device since it does not use a preheating transformer.

### Fifth Embodiment

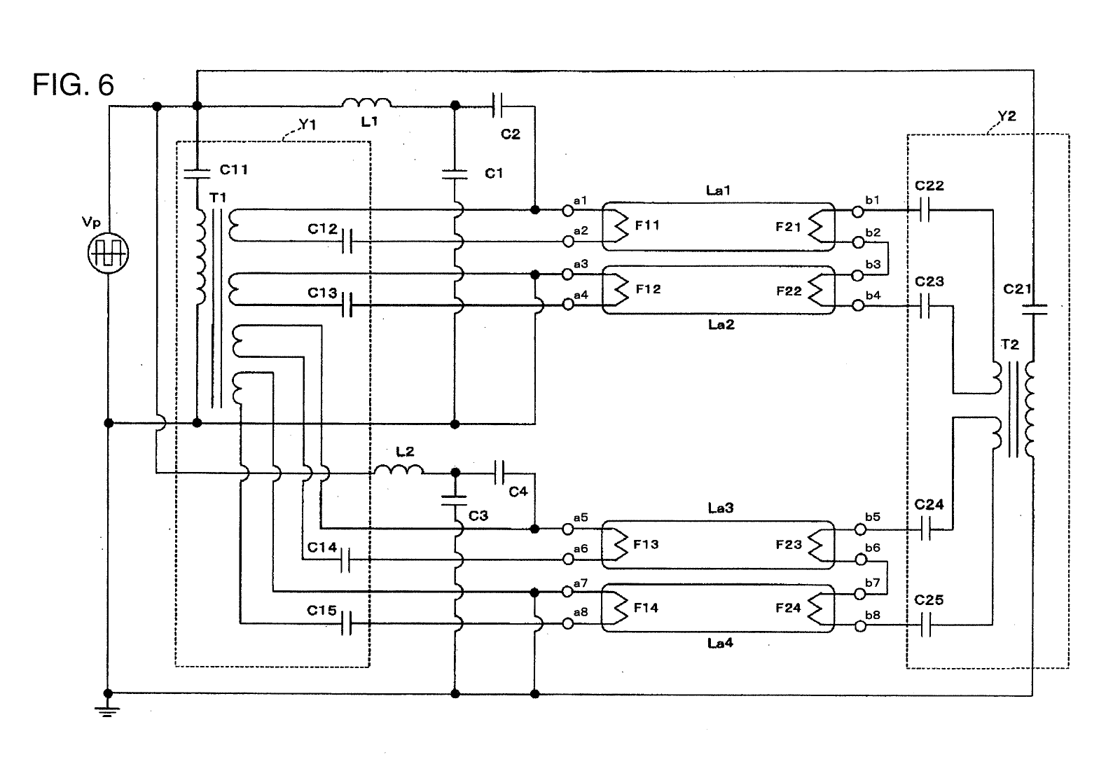

The lighting device according to the fifth embodiment is now explained with reference to FIG. 6. This lighting device comprises four hot-cathode lamps La1, La2, La3, La4, two lighting circuits for applying voltage to and lighting the four hot-cathode lamps, and two preheating circuits for preheating the filaments of the four hot-cathode lamps.

The first lighting circuit is configured from the positive/negative symmetrical square wave voltage Vp output as a result of a half bridge inverter circuit or a full bridge inverter circuit switching the DC voltage, and a serial resonance circuit of an inductor L1 and a capacitor C1 using the Vp as its power source. Both ends of the resonance capacitor C1 are connected to a series circuit of the DC cut capacitor C2 and the hot-cathode lamps La1 and La2.

The second lighting circuit is configured from a square wave voltage Vp, and a serial resonance circuit of an inductor L2 and a capacitor C3 using the Vp as its power source. Both ends of the resonance capacitor C3 are connected to a series circuit of the DC cut capacitor C4 and the hot-cathode lamps La3 and La4. In other words, in present embodiment, there are two lighting circuits, and one lighting circuit applies voltage and lights two hot-cathode lamps in series.

The preheating circuit is configured from a preheating circuit (non-serial-connection side preheating circuit) Y1 for preheating the filaments (F11, F12, F13, F14) on the side that is opposite to the serial-connection side of the two hot-cathode lamps connected in series, and a preheating circuit (serial-connection side preheating circuit) Y2 for preheating the serial-connection side filaments (F21, F22, F23, F24) of the two hot-cathode lamps connected in series. Specifically, the filaments at both ends of the respective hot-cathode lamps are separately preheated by the preheating circuit Y1 and the preheating circuit Y2.

The preheating circuit Y1 uses the square wave voltage Vp as its power source, and is configured from the capacitor C11 and a primary wiring of the preheating transformer T1. The preheating transformer T1 includes four secondary windings, and the respective secondary windings are connected to the filaments (F11, F12, F13, F14) on the side that is opposite to the serial-connection side of the two hot-cathode lamps connected in series, and respectively preheat the filaments via the capacitors C12, C13, C14, C15.

The preheating circuit Y2 uses the square wave voltage Vp as its power source, and is configured by connecting a series circuit of a primary winding of the capacitor C21 and the preheating transformer T2 to the power source Vp. The preheating transformer T2 includes two secondary windings, and the respective secondary windings are connected to the serial-connection side filaments (F21, F22, F23, F24) of the two hot-cathode lamps connected in series, and one preheats in a series loop of capacitor C22→filament F21→filament F22→capacitor C23, and the other preheats in a series loop of capacitor C24→filament F23→filament F24→capacitor C25. Although two capacitors were inserted into the series loop, only one capacitor may be inserted.

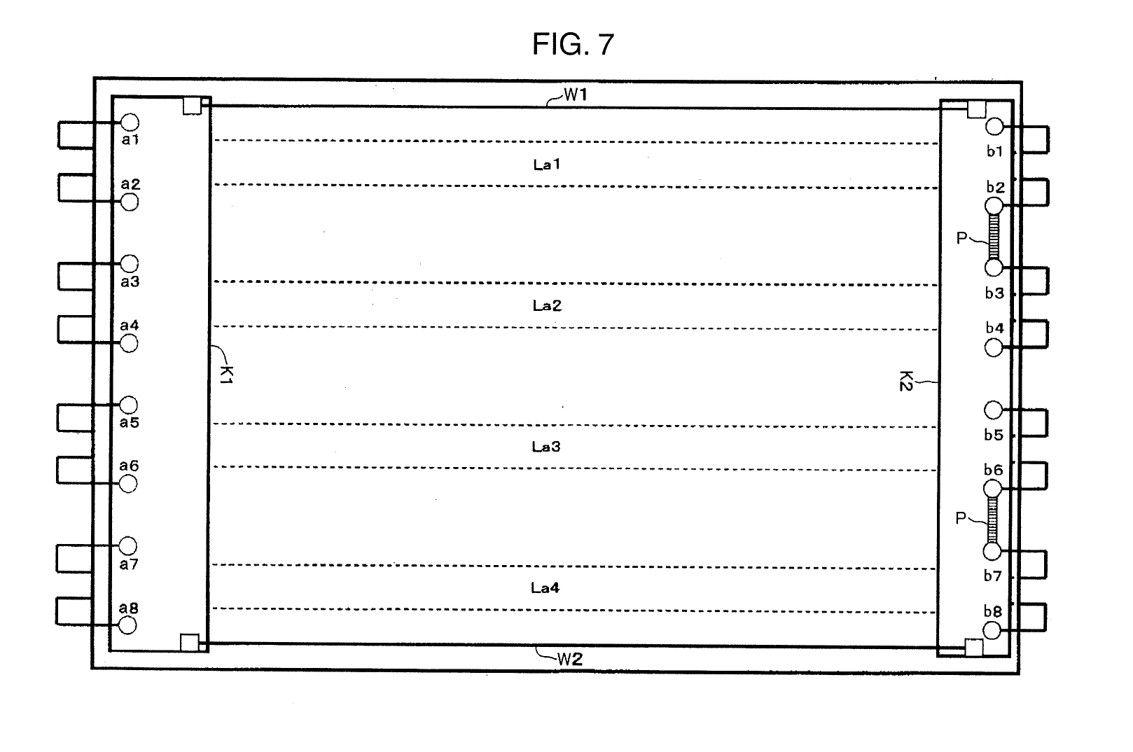

The filaments of both ends of the respective hot-cathode lamp are preheated separately with the preheating circuit Y1 and the preheating circuit Y2. The present embodiment is additionally characterizes in that the preheating circuit Y1 and the preheating circuit Y2 are packaged in different circuit substrates. The configuration of the backlight unit comprising the lighting device of the present embodiment shown in FIG. 6 is now explained with reference to FIG. 7.

FIG. 7 shows the configuration of the backlight unit comprising the lighting device packaged with the circuit substrate K1 and the circuit substrate K2, and FIG. 14 is a view from the reverse side of the backlight. For example, the circuit substrate K1 is packaged with the lighting circuit and the preheating circuit Y1 of the lighting device shown in FIG. 6, and the circuit substrate K2 is packaged with the preheating circuit Y2. As the circuit substrate material, paper phenol, glass epoxy and the like are generally used.

Only two wires (wire W1 and wire W2 of FIG. 7) for supplying power to the preheating circuit Y2 that is packaged in the circuit substrate K2 are required as the wiring between the circuit substrate K1 and the circuit substrate K2.

To explain the wiring to the hot-cathode lamps in FIG. 7, a terminal al and a terminal a2 of the circuit substrate K1 in which the lighting circuits and the preheating circuit Y1 are packaged are wired to the filament F11 of the hot-cathode lamp La1, a terminal a3 and a terminal a4 are wired to the filament F12 of the hot-cathode lamp La2, a terminal a5 and a terminal a6 are wired to the filament F13 of the hot-cathode lamp La3, and a terminal a7 and a terminal a8 are wired to the filament F14 of the hot-cathode lamp La4. Moreover, a terminal b1 and a terminal b2 of the circuit substrate K2 in which the preheating circuit Y2 is packaged are wired to the filament F21 of the hot-cathode lamp La1, a terminal b3 and a terminal b4 are wired to the filament F22 of the hot-cathode lamp La2, a terminal b5 and a terminal b6 are wired to the filament F23 of the hot-cathode lamp La3, and a terminal b7 and a terminal b8 are wired to the filament F24 of the hot-cathode lamp La4. However, since the terminal b2, the terminal b3, the terminal b6, and the terminal b7 are a terminal of the same potential, they are connected via a pattern on the circuit substrate K2 as shown in FIG. 7.

The configuration of the lighting device and the backlight unit of the present embodiment is as explained above, and now the effect thereof is explained. Foremost, as a result of preheating filaments (F11, F12, F13, F14) on one side of the hot-cathode lamps La1, La2, La3, La4 with the preheating circuit Y1, preheating filaments (F21, F22, F23, F24) on the other side of the hot-cathode lamps La1, La1, La3, La4 with the preheating circuit Y2, and packaging the preheating circuit Y1 and the preheating circuit Y2 separately in the circuit substrate K1 and the circuit substrate K2 disposed at the backlight reverse side of the backlight, the conventional lamp wires shown in FIG. 17 can be significantly reduced, and the lighter weight and miniaturization of the backlight unit are enabled.

Moreover, as a result of using the lighting circuit to light two hot-cathode lamps in series and arranging the hot-cathode lamp in a approximate U-shape as a result of bending the hot-cathode tube in the opposite direction at the serially connected portion, if the lighting device of the present embodiment is mounted on a backlight unit, the lamp current of the adjacent hot-cathode lamps can be made to be an opposite phase, which was not possible with the configuration of Patent Document 1 shown in FIG. 18. The result is a lighting device capable of setting off the magnetic field generated from the hot-cathode lamp and reducing the noise to the liquid crystal panel. Moreover, although four lighting circuits were required in the first embodiment, as a result of connecting the two hot-cathode lamps in series in the present embodiment, the hot-cathode lamps can be lit with only two lighting circuits.

### Sixth Embodiment

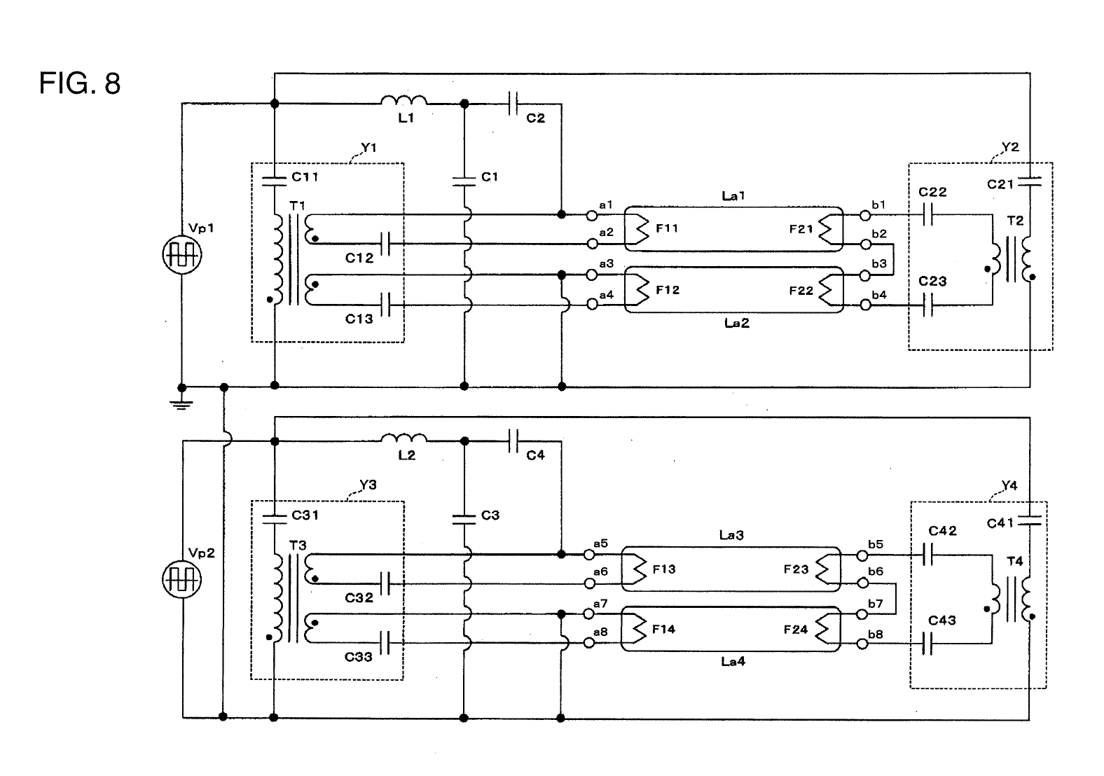

The lighting device according to the sixth embodiment is now explained with reference to FIG. 8. This lighting device comprises four hot-cathode lamps La1, La2, La3, La4, two lighting circuits for applying voltage to and lighting the four hot-cathode lamps, and four preheating circuits for preheating the filaments of the four hot-cathode lamps.

The first lighting circuit is configured from the positive/negative symmetrical square wave voltage Vp1 output as a result of a half bridge inverter circuit or a full bridge inverter circuit switching the DC voltage, and a serial resonance circuit of an inductor L1 and a capacitor C1 using the Vp1 as its power source. Both ends of the resonance capacitor C1 are connected to a series circuit of the DC cut capacitor C2 and the hot-cathode lamps La1 and La2.

The second lighting circuit is configured from the positive/negative symmetrical square wave voltage Vp2, and a serial resonance circuit of an inductor L2 and a capacitor C3 using the Vp2 as its power source. Both ends of the resonance capacitor C3 are connected to a series circuit of the DC cut capacitor C4 and the hot-cathode lamps La3 and La4. Here, let it be assumed that the power sources Vp1 and Vp2 are in synch.

The preheating circuit is configured from a preheating circuit (non-serial-connection side preheating circuit) Y1 for preheating the filaments F11, F12 on the side that is opposite to the serial-connection side of the two hot-cathode lamps connected in series, a preheating circuit (non-serial-connection side preheating circuit) Y3 for preheating the filaments F13, F14, a preheating circuit (serial-connection side preheating circuit) Y2 for preheating serial-connection side filaments F21, F22 of the two hot-cathode lamps connected in series, and a preheating circuit (serial-connection side preheating circuit) Y4 for preheating the filaments F23, F24.

The preheating circuit Y1 uses the square wave voltage Vpl as its power source, and is configured from a series circuit of a primary winding of the capacitor C11 and the preheating transformer T1. The preheating transformer T1 includes two secondary windings, and the respective secondary windings are connected to the filaments F11, F12 on the side that is opposite to the serial-connection side of the two hot-cathode lamps La1, La2 connected in series, and respectively preheat the filaments via the capacitors C12, C13. The preheating circuit Y3 uses the square wave voltage Vp2 as its power source, is configured the same as the preheating circuit Y1, and preheats the filaments F13, F14 on the side that is opposite to the serial-connection side of the hot-cathode lamps La1, La4.

Meanwhile, the preheating circuit Y2 uses the square wave voltage Vp1 as its power source, and is configured from a series circuit of a primary winding of the capacitor C21 and the preheating transformer T2. The preheating transformer T2 includes one secondary winding, and the secondary winding is connected to the serial-connection side filaments F21, F22 of the two hot-cathode lamps La1, La2 connected in series, and preheats in a series loop of capacitor C22→filament F21→filament F22→capacitor C23.

The preheating circuit Y4 uses the square wave voltage Vp2 as its power source, is configured the same as the preheating circuit Y2, and preheats the serial-connection side filaments F23, F24 of the two hot-cathode lamps La3, La4 connected in series.

The preheating circuit Y1 preheats the filaments F11, F12 on the side that is opposite to the serial-connection side of the hot-cathode lamps La1, La2, the preheating circuit Y2 preheats the serial-connection side filaments F21, F22 of the hot-cathode lamps La1, La2, the preheating circuit Y3 preheats the filaments F13, F14 on the side that is opposite to the serial-connection side of the hot-cathode lamps La3, La4, and the preheating circuit Y4 preheats the serial-connection side filaments F23, F24 of the hot-cathode lamps La3, La4 as explained above. The present embodiment is additionally characterized in that the preheating circuit Y1, the preheating circuit Y2, the preheating circuit Y3, and the preheating circuit Y4 are packaged in different circuit substrates.

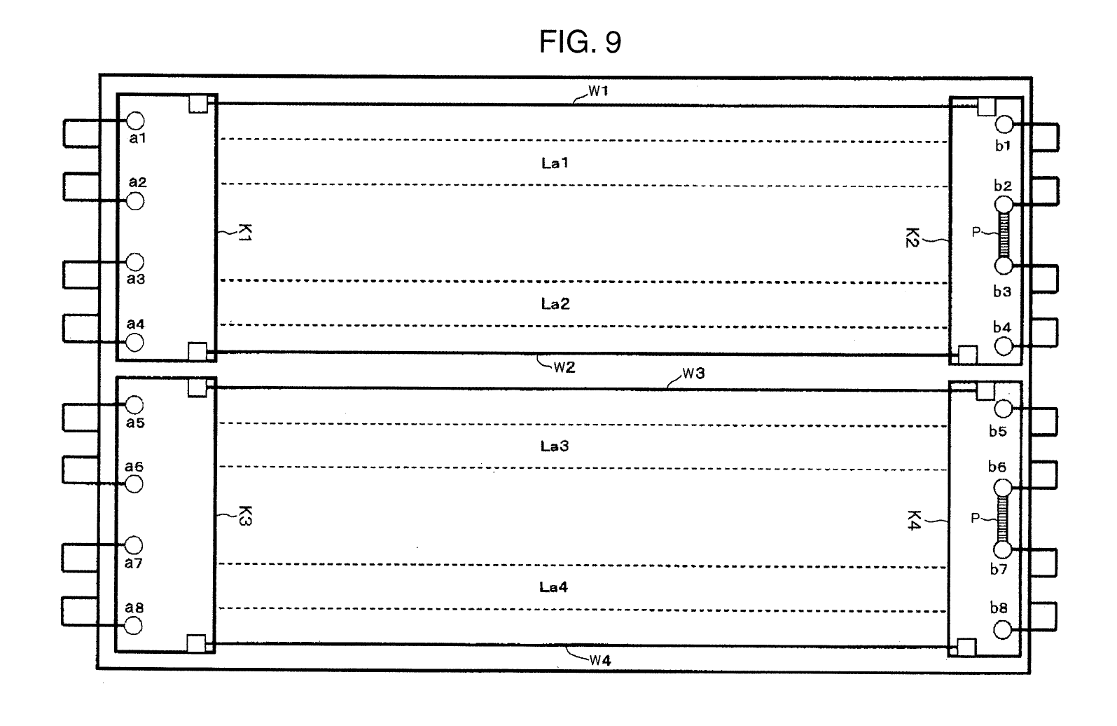

The configuration of the backlight unit comprising the lighting device of the present embodiment shown in FIG. 8 is now explained with reference to FIG. 9. For example, the circuit substrate K1 is packaged with the lighting circuit and the preheating circuit Y1, which use the square wave voltage Vp1 as the power source, of the lighting device shown in FIG. 8, and the circuit substrate K2 is packaged with the preheating circuit Y2. The circuit substrate K3 is packaged with the lighting circuit and the preheating circuit Y3, which use the square wave voltage Vp2 as the power source, of the lighting device shown in FIG. 8, and the circuit substrate K4 is packaged with the preheating circuit Y4. The square wave voltage Vpl as the power source of the preheating circuit Y2 is connected from the circuit substrate K1 to the circuit substrate K2 with the wire W1 and the wire W2, and the square wave voltage Vp2 as the power source of the preheating circuit Y4 is connected from the circuit substrate K3 to the circuit substrate K4 with the wire W3 and the wire W4. The explanation of the wiring from the circuit substrate to the hot-cathode lamp is omitted since it is the same as the fifth embodiment.

The effect of the present embodiment is now explained. With the present embodiment, in comparison to the configuration of the lighting device shown in FIG. 17, the number of lamp wires can be reduced significantly, and noise can be reduced since the lamp current of the adjacent hot-cathode lamps of the backlight unit can be made to be of an opposite phase. The present embodiment is additionally characterized in that one power source, one lighting circuit, and two preheating circuits are used to light two hot-cathode lamps connected in series, even if the size of the backlight unit becomes large and the number of lamps is increased, if the number of lamps is an even number, the lighting device of the present embodiment can be simply increased and arranged to accommodate the foregoing need. However, the plurality of power sources need to be in synch in order to make the lamp current of the adjacent hot-cathode lamps to be of an opposite phase.

### Seventh Embodiment

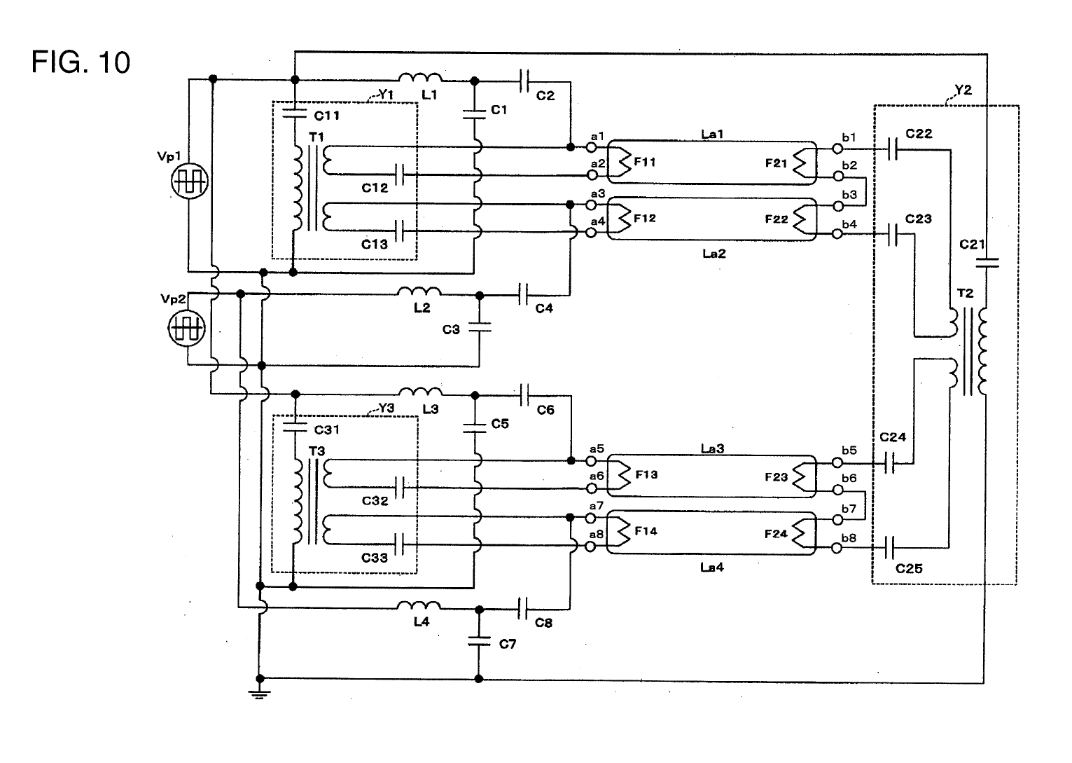

The light device according to the seventh embodiment is now explained with reference to FIG. 10. This lighting device comprises four hot-cathode lamps La1, La2, La3, La4, four lighting circuits for applying voltage to and lighting the four hot-cathode lamps, and three preheating circuits for preheating the filaments of the four hot-cathode lamps.

The first lighting circuit is configured from the positive/negative symmetrical square wave voltage Vp1, and a serial resonance circuit of an inductor L1 and a capacitor C1 using the Vp1 as the power source, and the second lighting circuit is configured from the square wave voltage Vp2 having an opposite phase of the square wave voltage Vp1, and a serial resonance circuit of an inductor L2 and a capacitor C3 using the Vp2 as the power source.

Here, one end of the respective resonance capacitors C1 and C3 is grounded, and a series circuit of the DC cut capacitor C2, the hot-cathode lamps La1 and La2, and the DC cut capacitor C4 is connected between the [grounded end] and the ungrounded end of the resonance capacitors C1 and C3. Specifically, the lighting circuit of the present embodiment applies voltage to the two hot-cathode lamps connected in series based on a bilateral high voltage drive system.

The third lighting circuit is configured from the positive/negative symmetrical square wave voltage Vp1, and a serial resonance circuit of an inductor L3 and a capacitor C5 using the Vp1 as the power source, and the fourth lighting circuit is configured from the square wave voltage Vp2 having an opposite phase of the square wave voltage Vp1, and a serial resonance circuit of an inductor L4 and a capacitor C7 using the Vp2 as the power source.

Here, one end of the respective resonance capacitors C5 and C7 is grounded, and a series circuit of the DC cut capacitor C6, the hot-cathode lamps La3 and La4, and the DC cut capacitor C8 is connected between the [grounded end] and the ungrounded end of the resonance capacitors C5 and C7. Specifically, the lighting circuit of the present embodiment applies voltage to the two hot-cathode lamps connected in series based on a bilateral high voltage drive system.

The preheating circuit is configured from a preheating circuit (non-serial-connection side preheating circuit) Y1 for preheating the filaments F11, F12 on the side that is opposite to the serial-connection side of the two hot-cathode lamps connected in series, a preheating circuit (non-serial-connection side preheating circuit) Y3 for preheating the filaments F13, F14, and a preheating circuit (serial-connection side preheating circuit) Y2 for preheating the serial-connection side filaments F21, F22, F23, F24 of the two hot-cathode lamps connected in series. Here, since the configuration of the preheating circuits Y1 and Y3 is the same as the configuration explained in the third embodiment, and since the configuration of the preheating circuit Y2 is the same as the configuration explained in the fifth embodiment, the detailed explanation thereof is omitted.

The present embodiment is additionally characterized in that the four lighting circuits and the preheating circuits Y1 and Y3 are packaged in the same circuit substrate K1, and the preheating circuit Y2 is packaged in a different circuit substrate K2. The arrangement of the circuit substrates K1, K2 may be the same as FIG. 7.

The effect of the present embodiment is now explained. In addition to being able to reduce the number of lamp wires and reducing noise, since the present embodiment provides a lighting circuit of a bilateral high voltage drive system at both ends of two lamps connected in series, in comparison to the fifth embodiment, it is possible to output approximately twice the output voltage. Consequently, even if the backlight unit is enlarged, the lamp length becomes long, and the lamp voltage increases, lighting is still sufficiently possible.

### Eighth Embodiment

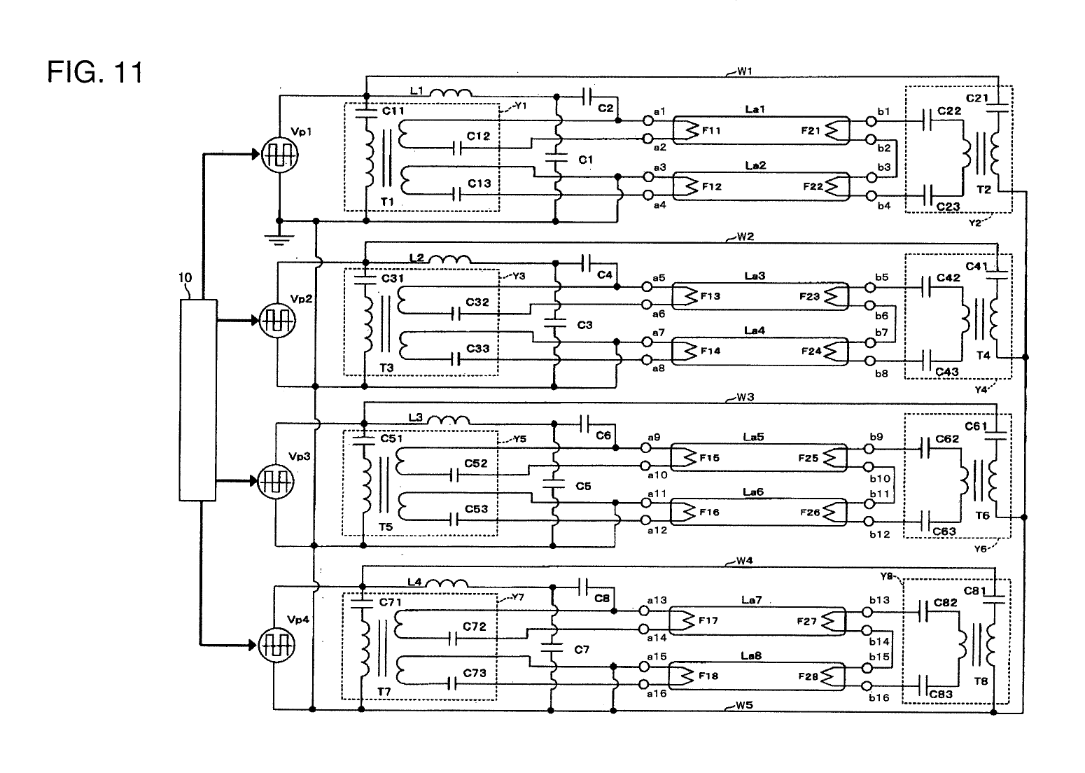

The lighting device according to the eighth embodiment is now explained with reference to FIG. 11. This lighting device comprises eight hot-cathode lamp La1 to La8, four lighting circuits for applying voltage to and lighting the eight hot-cathode lamps, eight preheating circuits for preheating the filaments of the eight hot-cathode lamps, and a flash/dimming control means for controlling the respective lighting circuits so enable the flash/dimming of the hot-cathode lamps.

The first lighting circuit is configured from the positive/negative symmetrical square wave voltage Vp1 output as a result of a half bridge inverter circuit or a full bridge inverter circuit switching the DC voltage, and a serial resonance circuit of an inductor L1 and a capacitor C1 using the Vp1 as its power source. A series circuit of the DC cut capacitor C2 and the hot-cathode lamps La1 and La2 is connected between both ends of the resonance capacitor C1. The second lighting circuit is configured from the square wave voltage Vp2, and a serial resonance circuit of an inductor L2 and a capacitor C3 using the Vp2 as the power source. A series circuit of the DC cut capacitor C4 and the hot-cathode lamps La3 and La4 is connected between both ends of the resonance capacitor C3. The third lighting circuit is configured from the square wave voltage Vp3, and a serial resonance circuit of an inductor L3 and a capacitor C5 using the Vp3 as the power source. A series circuit of the DC cut capacitor C6 and the hot-cathode lamps La5 and La6 is connected between both ends of the resonance capacitor C5. The fourth lighting circuit is configured from the square wave voltage Vp4, and a serial resonance circuit of an inductor L4 and a capacitor C7 using the Vp4 as the power source. A series circuit of the DC cut capacitor C8 and the hot-cathode lamps La1 and La8 is connected between both ends of the resonance capacitor C7.

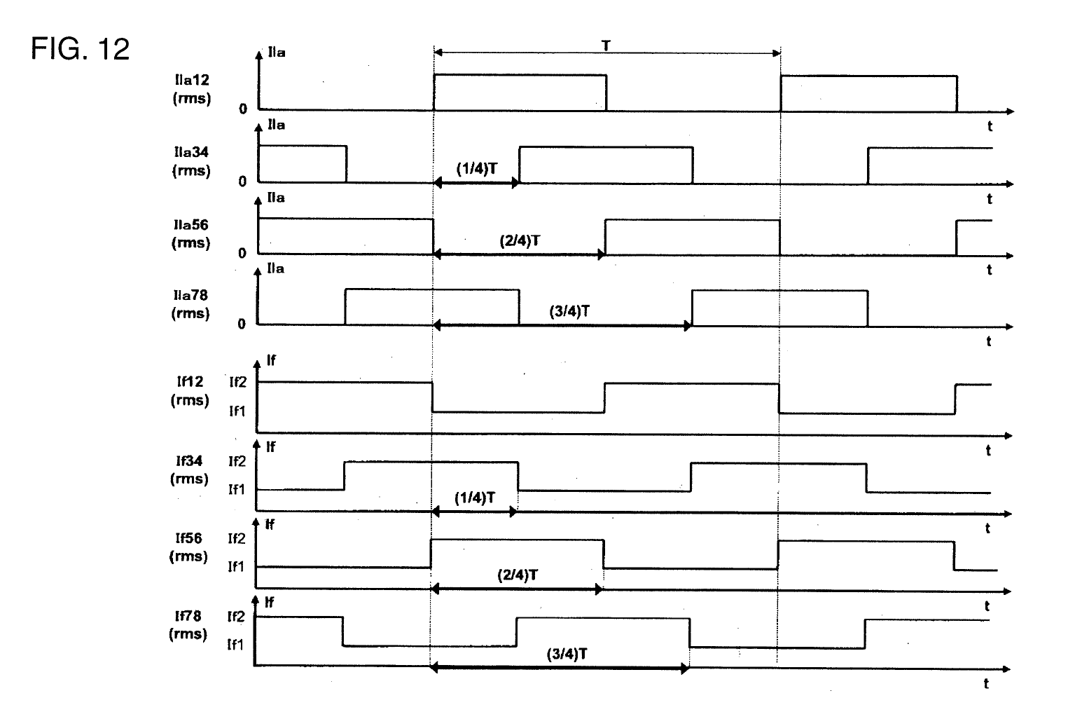

The respective lighting circuits are controlled by the flash/dimming control means, and flash/dim at a ratio of the ON period and OFF period of the lamp current of the connected hot-cathode lamps. Specifically, in order to form the ON period and OFF period of the lamp current and dim the lamps, the frequency of the square wave voltage of the lighting circuits is changed based on the ON period and the OFF period, and a frequency for outputting a lamp voltage that is able to maintain the lighting of the hot-cathode lamps during the ON period is set, and a frequency for outputting a lamp voltage that is unable to maintain the lighting of the hot-cathode lamps during the OFF period is set. FIG. 12 shows the lamp current effective value of the respective hot-cathode lamps upon flashing/dimming. Here, the effective value of the lamp current of the hot-cathode lamps La1 and La2 is Ila12, the effective value of the lamp current of the hot-cathode lamps La3 and La4 is Ila34, the effective value of the lamp current of the hot-cathode lamps La5 and La6 is Ila56, and the effective value of the lamp current of the hot-cathode lamps La7 and La8 is Ila78. As shown in FIG. 12, if one cycle of flashing is set as T and if the flashing cycle of Ila12 is used as the reference, Ila34 will flash with a phase delay of (¼)T, Ila56 will flash with a phase delay of ( 2/4)T, and Ila78 will flash with a phase delay of (¾) T. The phase difference of flash/dimming is controlled by the flash/dimming control means.

The preheating circuit is configured from a preheating circuit (non-serial-connection side preheating circuit) Y1 for preheating the filaments F11, F12 on the side that is opposite to the serial-connection side of the two hot-cathode lamps connected in series, a preheating circuit (non-serial-connection side preheating circuit) Y3 for preheating the filaments F13, F14, a preheating circuit (non-serial-connection side preheating circuit) Y5 for preheating the filaments F15, F16, a preheating circuit (non-serial-connection side preheating circuit) Y7 for preheating the filaments F17, F18, a preheating circuit (serial-connection side preheating circuit) Y2 for preheating the serial-connection side filaments F21, F22 of the two hot-cathode lamps connected in series, a preheating circuit (serial-connection side preheating circuit) Y4 for preheating the filaments F23, F24, a preheating circuit (serial-connection side preheating circuit) Y6 for preheating the filaments F25, F26, and a preheating circuit (serial-connection side preheating circuit) Y8 for preheating the filaments F27, F28. Specifically, the filaments at both ends of the respective hot-cathode lamps are preheated with different preheating circuits.

The preheating circuit Y1 uses the square wave voltage Vp1 as its power source, and is configured from a series circuit of a primary winding of the capacitor C11 and the preheating transformer T1. The preheating transformer T1 includes two secondary windings, and the respective secondary windings are connected to the filaments F11, F12 on the side that is opposite to the serial-connection side of the two hot-cathode lamps La1, La2 connected in series, and respectively preheat the filaments via the capacitors C12, C13. Since the configuration of the preheating circuits Y3, Y5, Y7 is the same although they have different square wave power sources, and the explanation thereof is omitted. Meanwhile, the preheating circuit Y2 uses the square wave voltage Vp1 as its power source, and is configured from a series circuit of a primary winding of the capacitor C21 and the preheating transformer T2. The preheating transformer T2 includes one secondary winding, and the secondary winding is connected to the serial-connection side filaments F21, F22 of the two hot-cathode lamps La1, La2 connected in series, and preheats in a series loop of capacitor C22→filament F21→filament F22→capacitor C23. Since the configuration of the preheating circuits Y4, Y6, Y8 is the same although they have different square wave power sources, the explanation thereof is omitted.

The preheating current effective value flowing through the filaments of the respective hot-cathode lamps in the case of flashing/dimming is shown in FIG. 12. Here, If12 is the effective value of the preheating current of the filaments F11, F12, F21, F22, If34 is the effective value of the preheating current of the filaments F13, F14, F23, F24, If56 is the effective value of the preheating current of the filaments F15, F16, F25, F26, and If78 is the effective value of the preheating current of the filaments F17, F18, F27, F28. Moreover, If1 is the effective value of the preheating current during the ON period of flash/dimming, and If2 is the effective value of the preheating current during the OFF period. The reason why the effective value of If2 is set to be higher than If1 is to supplement the electrode temperature that drops due to the flash/dimming by setting the preheating current of the OFF period to be higher than the preheating current of the ON period. Specifically, as a result of setting the frequency of the OFF period to be higher than the frequency of the ON period, during the OFF period, in comparison to the ON period, the impedance of the capacity on the primary side of the respective preheating circuits will decrease, the voltage that is applied to the primary winding of the preheating transformer that is serially connected with the capacitor will increase, and the impedance of the capacity on the secondary side of the preheating circuit will also decrease. Thus, the preheating current of the OFF period will increase in comparison to the preheating current of the ON period.

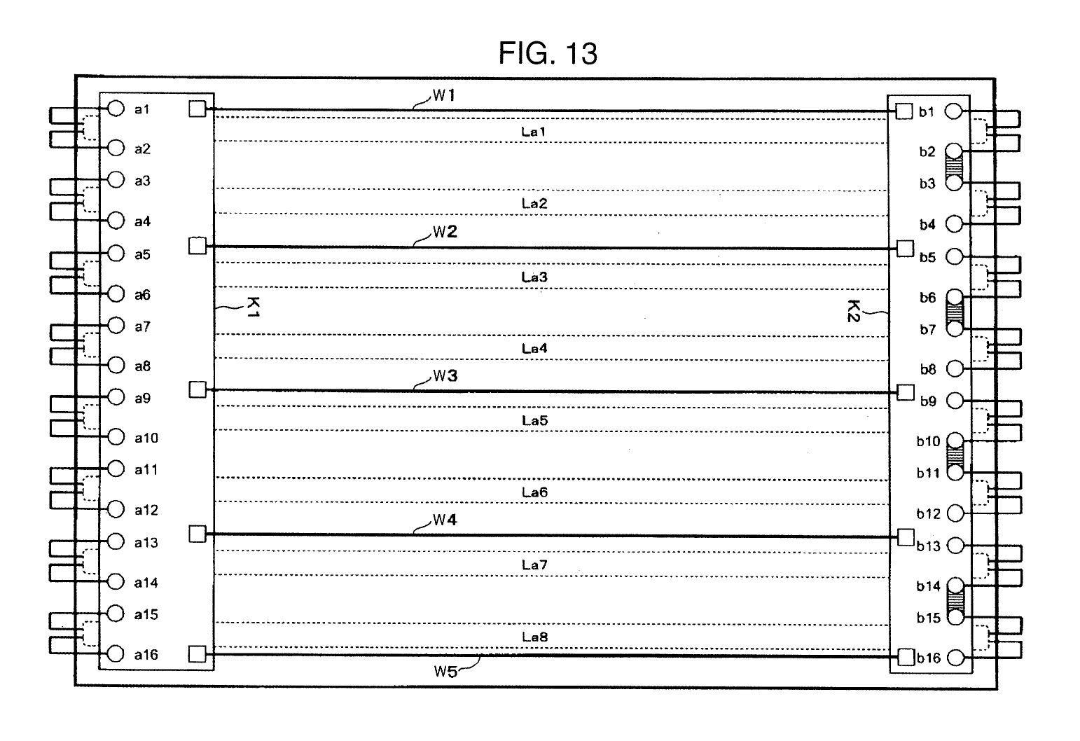

The backlight unit using the lighting device of the present embodiment is now explained with reference to FIG. 13. The circuit substrate K1 of FIG. 13 is packed with the four lighting circuits, the flash/dimming control means, and the four preheating circuits Y1, Y3, Y5, Y7, and the circuit substrate K2 is packaged with the four preheating circuits Y2, Y4, Y6, Y8. The wiring between the circuit substrate K1 and the circuit substrate K2 include a total of five wires; namely, the wire W1 as the power source wire of the preheating circuit Y2, the wire W2 as the power source wire of the preheating circuit Y4, the wire W3 as the power source wire of the preheating circuit Y6, the wire W4 as the power source wire of the preheating circuit Y8, and the wire W5 as the ground wire.

The effect of the present embodiment is now explained. In a circuit configuration in which a plurality of hot-cathode lamps are flashed/dimmed and the phase of the flash/dimming between the hot-cathode lamps is different, the lighting device of the present embodiment is able to reduce the number of preheating wires. For example, whereas sixteen low-voltage side wires were required for eight hot-cathode lamps with the conventional configuration of FIG. 17, in the present embodiment, the number of wires for connecting the circuit substrate K1 and the circuit substrate K2 can be reduced to five wires. Moreover, if the lighting device of the present embodiment is provided as a backlight of the liquid crystal display device, since the hot-cathode lamps will flash/dim, a considerable difference will occur in the luminous flux of the ON period and the OFF period, and the contrast ratio of the liquid crystal display device can be improved. Further, since the sequential lighting of changing the phase of the flash/dimming between the hot-cathode lamps is possible, the motion image performance of the liquid crystal display device can be improved.

### Ninth Embodiment

In the present embodiment, the wire winding direction of the preheating transformer is explained with reference to FIG. 8. The lamp current flowing in the serially connected hot-cathode lamps La1, La1 will flow in a loop of filament F11 (terminal al side)→filament F21→filament F22→filament F12 (ground of terminal a3 side) when the power source Vp1 is a positive voltage in relation to the ground potential. Moreover, when the power source Vp1 is a negative voltage in relation to the ground potential, it will flow in the reverse loop. Meanwhile, while the filament F11 and the filament F12 are preheated with the preheating transformer T1 and the filament F21 and the filament F22 are preheated with the preheating transformer T2, in the present embodiment, the start of the wire winding of the preheating transfrmers T1, T2 was set as shown with the preheating transfromers T1, T2 of FIG. 8 so that the resultant effective value of the filament current and the lamp current at the portion of the terminal a1, the terminal a3, the terminal b2, and the terminal b4 will be smaller than the effective value of the preheating current flowing in the respective filaments. The same configuration was adopted for the hot-cathode lamps La3, La4.

As a result of adopting the foregoing configuration, the resultant effective current can be reduced as the portion of the terminal a1, the terminal a3, the terminal b2, and the terminal b4, and the thinning of the wire diameter and the high efficiency of the lighting device can be achieved.

The lighting device according to one aspect of the present invention, as shown in FIG. 1 and FIG. 5, comprises a lighting circuit for lighting the plurality of hot-cathode lamps La1 to La4, a preheating circuit Y1 for preheating the respective filaments F11 to F14, F21 to F24 of the plurality of hot-cathode lamps La1 to La4, and a plurality of circuit substrates K1, K2, wherein at least one first circuit substrate K1 is packaged with the lighting circuit and a part of the preheating circuit Y1 (T1, C11 to C15), at least one second circuit substrate K2 is packaged or wired with a part of the preheating circuit Y1 (C22 to C25).

Specifically, the foregoing lighting device comprises: a lighting circuit for lighting a plurality of hot-cathode lamps having filaments at both ends; a preheating circuit for preheating the individual filaments of the plurality of hot-cathode lamps; at least one first circuit substrate arranged near filaments on one side of the plurality of hot-cathode lamps; and at least one second circuit substrate arranged near filaments on the other side of the plurality of hot-cathode lamps, wherein the lighting circuit is packaged in either the first circuit substrate or the second circuit substrate, and wherein the preheating circuit is packaged or wired by being divided in the first circuit substrate and the second circuit substrate.

According to the foregoing configuration, with the foregoing lighting device, since the first circuit substrate is disposed near filaments on one side of the plurality of hot-cathode lamps and the second circuit substrate is disposed near filaments on the other side, and the preheating circuit is packaged or wired by being divided in the first circuit substrate and the second circuit substrate, only two power source wires for preheating the filaments near one of the circuit substrates are required between the first circuit substrate and the second circuit substrate. Accordingly, the reduction in the number of lamp wires and the lighter weight of the lighting device can be realized. Moreover, if the first circuit substrate and the second circuit substrate are arranged on either side of the backlight unit, the weight balance is improved in comparison to a configuration of disposing the circuit substrates on one side.

In the foregoing configuration, the lighting device includes, as shown in FIG. 2 and FIG. 5, a plurality of preheating circuits Y1, Y2 for preheating the respective filaments F11 to F14, F21 to F24 of the plurality of hot-cathode lamps La1 to La4, the first circuit substrate K1 is packaged with the lighting circuit, the preheating circuit Y1 for preheating the filaments F11 to F14 near the first circuit substrate K1, and a part (C21, T2) of the preheating circuit Y2 for preheating the filaments F21 to F24 near the second circuit substrate K2, and the second circuit substrate K2 is packaged or wired with a part (C22 to C25) of the preheating circuit Y2 for preheating the filaments F21 to F24 near the second circuit substrate K2.

Specifically, with the foregoing lighting device, the preheating circuit includes a first preheating circuit for preheating a filament near the first circuit substrate, and a second preheating circuit for preheating a filament near the second circuit substrate, the lighting circuit, the first preheating circuit, and a part of the second preheating circuit are packed in the first circuit substrate, and a part of the second preheating circuit is packaged or wired in the second circuit substrate.

According to the foregoing configuration, since the lighting circuit and the first preheating circuit for preheating the filaments near the first circuit substrate are packaged in the first circuit substrate, and the second preheating circuit for preheating the filaments near the second circuit substrate is packaged or wired by being divided in the first circuit substrate and the second circuit substrate, only two power source wires for preheating the filaments near the second circuit substrates are required between the first circuit substrate and the second circuit substrate. Accordingly, the reduction in the number of lamp wires and the lighter weight of the lighting device can be realized. Moreover, by providing a plurality of preheating circuits, since the filaments near the first circuit substrate and the filaments near the second circuit substrate can be preheated with different preheating circuits, the filaments at both ends of the hot-cathode lamps can be preheated based on different preheating methods, and the freedom of design can be increased.

In the foregoing configuration, the lighting device includes, as shown in FIG. 3 and FIG. 5, a plurality of preheating circuits Y1, Y2, Y3 for preheating the respective filaments F11 to F14, F21 to F24 of the plurality of hot-cathode lamps La1 to La4, the first circuit substrate K1 is packaged with the lighting circuit, and the preheating circuits Y1 and Y3 for preheating the filaments F11 to F14 near the first circuit substrate K1, and the second circuit substrate K2 is packaged with the preheating circuit Y2 for preheating the filaments F21 to F24 near the second circuit substrate K2.

Specifically, in the foregoing lighting device, the preheating circuit includes a first preheating circuit for preheating a filament near the first circuit substrate, and a second preheating circuit for preheating a filament near the second circuit substrate, wherein the lighting circuit and the first preheating circuit are packaged in the first circuit substrate, and wherein the second preheating circuit is packaged in the second circuit substrate.

According to the foregoing configuration, since the filaments near the first circuit substrate and the filament near the second circuit substrate are preheated with different preheating circuits, and the preheating circuit is packaged in different circuit substrates, only two power source lines of the preheating circuit are required between the first circuit substrate and the second circuit substrate. Accordingly, the reduction in the number of lamp wires and the lighter weight of the lighting device can be realized. Moreover, since the preheating circuit is packaged in difference circuit substrates, if they are arranged on either side of the backlight unit, the lateral weight balance is improved in comparison to a configuration where components of the preheating circuit are concentrated on one circuit substrate. Further, since the filaments and the output of the preheating circuit can be connected at a short wiring distance, the inductance component of the preheat wire is small, and there is an effect of being able to reduce the variation in the preheating current of the respective filaments.

In the foregoing configuration, the foregoing lighting circuit, as shown in FIG. 1 to FIG. 5, applies a high-voltage AC voltage to an arbitrary filament among the filaments F11 to F14 near the first circuit substrate K1, and apply an AC voltage of a phase that is 180° different from the high-voltage AC voltage to a filament that is adjacent to the arbitrary filament, and lights the filaments F21 to F24 near the second circuit substrate K2 by connecting them to the ground.

Specifically, in the foregoing lighting device, the lighting circuit applies a first lighting AC voltage to an arbitrary filament among the filaments near the first circuit substrate, and applies a second lighting AC voltage of a phase that is 180° different from the first lighting AC voltage to a filament that is adjacent to the arbitrary filament, and lights the plurality of hot-cathode lamps by connecting a filament near the second circuit substrate to a ground potential.

According to the foregoing configuration, the lamp current flowing in the arbitrary hot-cathode lamp and the lamp current flowing in the adjacent hot-cathode lamp can be made to be of an opposite phase, and the magnetic field from the lamp current can be set off. Thus, a lighting device with low noise can be realized.

In the foregoing configuration, the foregoing lighting device includes, as shown in FIG. 3 and FIG. 5, a lighting circuit for lighting a plurality of hot-cathode lamps La1 to La4 having filaments at both ends of a glass tube, a plurality of preheating circuits Y1 to Y3 including at least preheating transformers T1 to T3 for preheating the filaments, and a plurality of circuit substrates K1, K2 for packaging at least the preheating circuits Y1 to Y3, wherein the high-voltage side filaments F11 to F14 and the low-voltage side filaments F21 to F24 of the plurality of hot-cathode lamps La1 to La4 are preheated with different preheating circuits, and the preheating circuits Y1, Y3 for preheating the high-voltage side filaments F11 to F14 and the preheating circuit Y2 for preheating the low-voltage side filaments F21 to F24 are packaged in different circuit substrates K1, K2.

Specifically, the foregoing lighting device comprises a lighting circuit for lighting a plurality of hot-cathode lamps having filaments at both ends, a preheating circuit including at least a preheating transformer for preheating the filaments, and a plurality of circuit substrates in which at least the preheating circuit is packaged, wherein the preheating circuit includes a high-voltage side preheating circuit for preheating a high-voltage side filament of the plurality of hot-cathode lamps, and a low-voltage side preheating circuit for preheating a low-voltage side filament of the plurality of hot-cathode lamps, and wherein the high-voltage side preheating circuit and the low-voltage side preheating circuit are packaged in different circuit substrates.

According to the foregoing configuration, since the high-voltage side filament and the low-voltage side filaments of the plurality of hot-cathode lamps are preheated with different preheating circuits, and the preheating circuit is packaged in different circuit substrates, only two power source wires are required for connecting the first circuit substrate packaged with the preheating circuit for preheating the high-voltage side filaments and the second circuit substrate packaged with the preheating circuit for preheating the low-voltage side filaments. Accordingly, the reduction in the number of lamp wires and the lighter weight of the lighting device can be realized. Moreover, since the preheating circuit is divided and packaged in different circuit substrates, if these are arranged on either side of the backlight unit, the weight balance is improved in comparison to a configuration of disposing the circuit substrates on one side.

In the foregoing configuration, the lighting device includes, as shown in FIG. 6 and FIG. 7, a lighting circuit for lighting two plurality of hot-cathode lamps La1, La2 (La3, La4) in series having filaments at both ends of a glass tube, a plurality of preheating circuits Y1, Y2 including at least preheating transformers T1, T2 for preheating the filaments, and a plurality of circuit substrates K1, K2 packaged at least with the preheating circuits Y1, Y2, wherein the serial-connection side filaments F21, F22 (F23, F24) and the non-serial connection side filaments F11, F12 (F13, F14) of the two hot-cathode lamps La1, La2 (La3, La4) connected in series are preheated with different preheating circuits Y2, Y1, and the preheating circuit Y2 for preheating the serial-connection side filaments F21, F22 (F23, F24) and the preheating circuit Y1 for preheating the non-serial connection side filaments F11, F12 (F13, F14) are packaged in different circuit substrates K2, K1.

Specifically, the foregoing lighting device comprises: a lighting circuit for lighting two of the plurality of hot-cathode lamps in series having filaments at both ends; a preheating circuit including at least a preheating transformer for preheating the filaments, and a plurality of circuit substrates in which at least the preheating circuit is packaged, wherein the preheating circuit includes a serial-connection side preheating circuit for preheating a serial-connection side filament of the two hot-cathode lamps connected in series, and a non-serial-connection side preheating circuit for preheating a non-serial connection side filament, and wherein the serial-connection side preheating circuit and the non-serial-connection side preheating circuit are packaged in different circuit substrates.

According to the foregoing configuration, since the lighting circuit lights two hot-cathode lamps in series and the serial-connection side filaments of the two hot-cathode lamps connected in series and the filaments on the side that is opposite to the serial-connection side are preheated with different reheating circuits (serial-connection side preheating circuit and non-serial-connection side preheating circuit), and the preheating circuits are packaged on different circuit substrates, only two power source wires are required for connecting the first circuit substrate packaged with the lighting circuit and the non-serial-connection side preheating circuit to the second circuit substrate packaged with the serial-connection side preheating circuit, the reduction in the number of lamp wires and the lighter weight of the lighting device can be realized.

In the foregoing configuration, the foregoing lighting circuit, as shown in FIG. 6 and FIG. 8, applies a high-voltage AC voltage to the non-serial connection side (terminals a1, a5) of the two hot-cathode lamps La1, La2 (La3, La4) connected in series, and connecting the other side (terminals a3, a7) to the ground, the two hot-cathode lamps La1, La2 (La3, La4) connected in series can be subject to unilateral high-voltage lighting.

Specifically, in the foregoing lighting device, the lighting circuit lights two hot-cathode lamps in series connection, and induces unilateral high-voltage lighting in the two hot-cathode lamps connected in series by applying a high-voltage AC voltage to filaments on one side, which is the non-serial connection side, of the two hot-cathode lamps connected in series, and connecting the filaments on the other side to a ground potential.

According to the foregoing configuration, the two hot-cathode lamps connected in series are subject to unilateral high-voltage lighting, and one lighting circuit can be used to light two lamps. In particular, the hot-cathode lamps have a low lamp voltage, lighting based on serial connection can be performed relatively easily.

In the foregoing configuration, the lighting circuit, as shown in FIG. 10, applies a high-voltage AC voltage to the non-serial connection side (terminals a1, a5) of the two hot-cathode lamps La1, La2 (La3, La4) connected in series, and applies and AC voltage having an opposite phase of the applied voltage to the other side (terminals a3, a7), and the two hot-cathode lamps La1, La2 (La3, La4) connected in series can be subject to bilateral high-voltage lighting.

Specifically, in the foregoing lighting device, the lighting circuit lights two hot-cathode lamps in series connection, and induces bilateral high-voltage lighting in the two hot-cathode lamps connected in series by applying a first lighting AC voltage to filaments on one side, which is the non-serial connection side, of the two hot-cathode lamps connected in series, and applying a second lighting AC voltage of an opposite phase to the first lighting AC voltage to filaments on the other side.

According to the foregoing configuration, since the two hot-cathode lamps connected in series are subject to bilateral high-voltage lighting, the applied voltage is double in comparison to the unilateral high-voltage lighting. Thus, even a long lamp can be lit.

In the foregoing configuration, the lighting device includes, as shown in FIG. 11 and FIG. 12, a plurality of the lighting circuits, wherein each lighting circuit performs flash/dimming at a ratio of the ON period and OFF period of the lamp current, the lighting device further includes flash/dimming control means for controlling the flash timing of the flash/dimming of each of the lighting circuits.

According to the foregoing configuration, since a considerable difference will occur in the luminous flux of the ON period and the OFF period, the contrast ratio of the liquid crystal display device can be improved. Further, since the sequential lighting of changing the phase of the flash/dimming between the hot-cathode lamps is possible, the motion image performance of the liquid crystal display device can be improved.

In the foregoing configuration, the lighting device is characterized in that the preheating circuit includes at least the preheating transformer as in the respective embodiments other than FIG. 4.

According to the foregoing configuration, since the preheating circuit is configured from the preheating transformer, regardless of the value of the primary side voltage of the preheating transformer, by adjusting the wire winding ratio, the secondary side voltage of the preheating transformer can be set to be constant relatively easily.

In the foregoing configuration, with the foregoing lighting device, as shown in FIG. 8, the preheating transformer is configured so that the resultant effective value of the lamp current flowing in the hot-cathode lamps La1 to La4 that are lit by the lighting circuit and the preheating current flowing from a secondary winding of the preheating transformers T1 to T4 of the preheating circuits Y1 to Y4 to the filaments will be smaller than the effective value of the preheating value flowing from the secondary winding of the preheating transformers T1 to T4 to the filaments.

According to the foregoing configuration, the resultant effective current can be reduced as the portion of the terminal a1, the terminal a3, the terminal b2, and the terminal b4, and the thinning of the wire diameter and the high efficiency of the lighting device can be achieved.

The backlight unit according to one aspect of the present invention comprises the lighting device described above.

Since the backlight unit of the foregoing configuration comprises the foregoing lighting device, it is light with few wires, noise to the liquid crystal panel is small, and the far field that is generated from the liquid crystal display device comprising the backlight unit is also small.

The liquid crystal display device according to another aspect of the present invention comprises the backlight unit described above.

It is thereby possible to realize a light and compact liquid crystal display device with few wires.

### INDUSTRIAL APPLICABILITY

The lighting device of the present invention can be suitably used as a backlight unit of an illuminating device, in particular a liquid crystal display device that uses the plurality of hot-cathode lamps.

1. A lighting device, comprising
a lighting circuit for lighting a plurality of hot-cathode lamps having filaments at both ends;
a preheating circuit for preheating the individual filaments of the plurality of hot-cathode lamps;
at least one first circuit substrate arranged near filaments on one side of the plurality of hot-cathode lamps; and
at least one second circuit substrate arranged near filaments on the other side of the plurality of hot-cathode lamps, wherein
the lighting circuit is packaged in either the first circuit substrate or the second circuit substrate, and
the preheating circuit is packaged or wired by being divided in the first circuit substrate and the second circuit substrate.

2. The lighting device according to claim 1, wherein
the preheating circuit includes a first preheating circuit for preheating a filament near the first circuit substrate, and a second preheating circuit for preheating a filament near the second circuit substrate,
the lighting circuit, the first preheating circuit, and a part of the second preheating circuit are packed in the first circuit substrate, and
the part of the second preheating circuit is packaged or wired in the second circuit substrate.

3. The lighting device according to claim 1, wherein
the preheating circuit includes a first preheating circuit for preheating a filament near the first circuit substrate, and a second preheating circuit for preheating a filament near the second circuit substrate,
the lighting circuit and the first preheating circuit are packaged in the first circuit substrate, and
the second preheating circuit is packaged in the second circuit substrate.

4. The lighting device according to claim 1, wherein the lighting circuit applies a first lighting AC voltage to an arbitrary filament among the filaments near the first circuit substrate, and applies a second lighting AC voltage of a phase that is 180° different from the first lighting AC voltage to a filament that is adjacent to the arbitrary filament, and lights the plurality of hot-cathode lamps by connecting a filament near the second circuit substrate to a ground potential.

5. A lighting device, comprising:
a lighting circuit for lighting a plurality of hot-cathode lamps having filaments at both ends;
a preheating circuit including at least a preheating transformer for preheating the filaments; and
a plurality of circuit substrates in which at least the preheating circuit is packaged, wherein
the preheating circuit includes a high-voltage side preheating circuit for preheating a high-voltage side filament of the plurality of hot-cathode lamps, and a low-voltage side preheating circuit for preheating a low-voltage side filament of the plurality of hot-cathode lamps, and
the high-voltage side preheating circuit and the low-voltage side preheating circuit are packaged in different circuit substrates.

6. A lighting device, comprising:
a lighting circuit for lighting two of the plurality of the hot-cathode lamps in series having filaments at both ends;
a preheating circuit including at least a preheating transformer for preheating the filaments; and
a plurality of circuit substrates in which at least the preheating circuit is packaged, wherein
the preheating circuit includes a serial-connection side preheating circuit for preheating a serial-connection side filament of the two hot-cathode lamps connected in series, and a non-serial-connection side preheating circuit for preheating a non-serial connection side filament, and
the serial-connection side preheating circuit and the non-serial-connection side preheating circuit are packaged in different circuit substrates.

7. The lighting device according to claim 2, wherein the lighting circuit lights two hot-cathode lamps in series connection, and induces unilateral high-voltage lighting in the two hot-cathode lamps connected in series by applying a high-voltage AC voltage to filaments on one side, which is the non-serial connection side of the two hot-cathode lamps connected in series, and connecting filaments on the other side to a ground potential.

8. The lighting device according to claim 2, wherein the lighting circuit lights two hot-cathode lamps in series connection, and induces bilateral high-voltage lighting in the two hot-cathode lamps connected in series by applying a first lighting AC voltage to filaments on one side, which is the non-serial connection side, of the two hot-cathode lamps connected in series, and applying a second lighting AC voltage of an opposite phase to the first lighting AC voltage to the other filament.

9. The lighting device according to claim 1 comprising a plurality of the lighting circuits, wherein
each lighting circuit performs flash/dimming at a ratio of the ON period and OFF period of the lamp current,
the lighting device further including flash/dimming control means for controlling the flash timing of the flash/dimming of each of the lighting circuits.

10. The lighting device according to claim 1, wherein the preheating circuit includes at least a preheating transformer.

11. The lighting device according to claim 5, wherein the preheating transformer is configured so that the resultant effective value of the lamp current flowing in the hot-cathode lamp that is lit by the lighting circuit and the preheating current flowing from a secondary winding of the preheating transformer of the preheating circuit to the filament is smaller than the effective value of the preheating value flowing from the secondary winding of the preheating transformer to the filament.

12. A backlight unit comprising the lighting device according to claim 1.

13. A liquid crystal display device comprising the backlight unit according to claim 12.
